(19) United States
(12) Patent Application Publication
(10) Pub. No.: US 2015/0124088 A1
(43) Pub. Date: May 7, 2015

(54) TUBULAR CAMERA MODULE

(71) Applicant: Scopix Inc., Burlingame, CA (US)

(72) Inventors: Luis Vera, Burlingame, CA (US); Ariel Schilkrut, Burlingame, CA (US)

(73) Assignee: Scopix Inc., Burlingame, CA (US)

(21) Appl. No.: 14/083,011

(22) Filed: Nov. 18, 2013

Related U.S. Application Data
(60) Provisional application No. 61/727,496, filed on Nov. 16, 2012.
(60) Provisional application No. 61/752,814, filed on Jan. 15, 2013.

(51) Int. Cl. G08B 13/196; H04N 5/232; H04N 21/2743; G03B 17/56; H04N 5/225

(52) U.S. Cl. CPC G08B 13/19632; G03B 17/561; H04N 5/2252; G08B 13/19619; H04N 21/2743; H04N 5/23206
USPC 348/143

(57) ABSTRACT

A tubular camera module is disclosed. An example tubular camera module includes a tube-shaped object including a camera seat portion, the tube-shaped object being positioned along a top of a first store shelf that is adjacent to a second store shelf, the first and second store shelves being separated by an aisle and a camera module connected to the tube-shaped object at the camera seat portion. The camera module includes a camera housing having edges that align with edges of the camera seat portion, a camera having a lens that is positioned to image at least a portion of the second store shelf, and a transmitter configured to transmit images of the portion of the second store shelf to a communicatively coupled server.

### PRIORITY CLAIM

The present application claims priority to and the benefit of U.S. Provisional Patent Application No. 61/727,496, filed on Nov. 16, 2012, and U.S. Provisional Patent Application No. 61/752,814, filed on Jan. 15, 2013, the entirety of which are incorporated herein by reference.

### BACKGROUND

Currently, in-store cameras are configured for security or consumer monitoring purposes. For instance, in-store cameras are typically positioned within an indoor retail environment to monitor activity around entrances/exits, cashiers, and/or high value items. Additionally, some stores use cameras that are positioned to monitor consumer behavior among products. These security and consumer monitoring cameras are typically positioned close to ceilings or walls to provide maximum retail area coverage.

A drawback of this positioning is that not all of the products are within view of the cameras. For instance, shelves facing away from a camera can visually block coverage of products on those shelves. Additionally, building supports, displays, and/or walls can visually block a camera's view of some products. As product manufacturers use product analytics, a need exists to provide in-store cameras that provide monitoring of all products on a shelf while at the same time being relatively inconspicuous to consumers.

### SUMMARY

The present disclosure provides a new and innovative tubular camera module. The example tubular camera module is configured to be placed along a store shelf to record at least a portion of an oppositely located store shelf. In particular, the tubular camera module is configured to record products on store shelves and transmit these images and/or video to a server so that an interested party can analyze, for example, how consumers interact with a particular product on the shelf. The analysis can include determining an amount of time a consumer views products on a shelf before selecting a product, determining a number of products selected within different time periods, determining how product placement on a particular shelf correlates with product selection, etc.

The example tubular camera module is configured to be visually inconspicuous to consumers by having a slender profile that blends in with the profile of store shelving. In an embodiment, the example tubular camera module is located within or connected to a tubular support that is positioned parallel to the top of store shelving. The tubular support may be connected to the top of the store shelving or hung from a ceiling directly above store shelving. In a second embodiment, the example tubular camera module is located within a tubular support that is positioned in a mid-section of store shelving.

In an example, the tubular camera module includes a tube-shaped object including a camera seat portion, the tube-shaped object being positioned along a top of a first store shelf that is adjacent to a second store shelf, the first and second store shelves being separated by an aisle. The tubular camera module also includes a camera module connected to the tube-shaped object at the camera seat portion. The camera module includes a camera housing having edges that align with edges of the camera seat portion, a camera having a lens that is positioned to image at least a portion of the second store shelf, and a transmitter configured to transmit images of the portion of the second store shelf to a communicatively coupled server.

In another example, the tubular camera system includes an elongated housing configured to be mounted to a retail store shelving unit, the housing including at least two cameras configured to face a second adjacent shelving unit.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of an in-store monitoring environment that includes a camera system positioned atop a store shelf.

FIGS. 2A and 2B show diagrams of embodiments as to how the camera system of FIG. 1 is supported within the monitoring environment.

FIG. 2C shows a front-perspective view of the camera system of FIG. 2B.

FIG. 3 shows a diagram of a system implementation of the monitoring environment of FIG. 1.

FIG. 4 shows a diagram of a side perspective view of a camera system including leg sections.

FIG. 5 shows a diagram of an angled perspective view of the camera system of FIG. 4.

FIG. 6 shows a diagram of a camera module connected to tube sections at a first end and a second end.

FIG. 7 shows a schematic diagram of an assembly of a camera system.

FIG. 8 shows a schematic diagram of an assembly of two camera modules.

FIG. 9 shows a diagram of an assembly of two camera modules connected together via a connector.

FIGS. 10 and 11 show schematic diagrams of joint sections of the camera system of FIG. 5.

FIG. 12 shows a schematic diagram of an assembly of a leg section of the camera system of FIG. 5.

FIGS. 13A to 13D show different perspective views of an assembled camera module.

FIGS. 14 and 15 show diagrams of exploded views of the front housing of a camera module.

FIGS. 16 to 19 show assemblies of circuit boards with a photo detector and a camera lens.

FIGS. 20, 21A, and 21B show diagrams of a completed assembly of a front housing prior to insertion into a rear housing.

FIG. 22 shows a diagram of a front housing assembled with a rear housing to form an assembled camera module.

FIGS. 23 to 25 show diagrams of example electrical connectors configured to electrically couple a front housing to a rear housing of a camera module.

FIGS. 26 to 28 show diagrams of a first alternative camera module that may be used with the camera system of FIGS. 1 to 3.

FIGS. 29 to 36 show diagrams of a second alternative camera module that may be used with the camera system of FIGS. 1 to 3.

### DETAILED DESCRIPTION

The present disclosure relates in general to an apparatus and system to monitor products located on store shelving and, in particular, a tubular camera module positioned in parallel with store shelving to monitor products while being relatively inconspicuous to consumers. Briefly, in an example embodiment, a camera system includes at least one tube-shaped camera module disposed in-line between tube-shaped objects. The tube-shaped objects include other camera modules, tube-sections without camera modules, and/or connectors. The camera module and tube-shaped objects are positioned along a first direction that is parallel to store shelves. The camera module is disposed such that a camera lens included in the camera module is positioned to face a second direction that is perpendicular to the first direction so as to enable a camera to monitor products on an opposite store shelf. The tube-shaped objects may be connected to the top of store shelving via one or more leg sections. Alternatively, the tube sections may be hung from a store ceiling via one or more supports. In another embodiment, the tube-shaped objects may be positioned along a front ledge of store shelves.

The tubular camera module includes a front housing and a rear housing. In some embodiments, the rear housing provides coupling to tube-shaped objects while the front housing encloses a camera assembly (e.g., camera lens, lens holder, video processor, memory, data processor, communication processor, circuit board, etc.). In other embodiments, the front housing includes the camera assembly in addition to tube-shaped object connectors. In these other embodiments, the rear housing provides a rear case that enables the camera module to aesthetically blend with adjacent tube-shaped objects, thereby remaining inconspicuous to consumers.

In the present disclosure, the rear housing includes at least one mechanical connector that enables the front housing to be connected to the rear housing (or the rear housing to be connected to the front housing). The rear housing may also include one or more electrical connectors to provide power to a camera and associated processors included within the front housing or facilitate communications between the camera/processors and separately located processors, servers, computers, etc. Alternatively, the rear housing may not include an electrical connector. In these alternative embodiments, the camera may wirelessly transmit and receive communications from a separately located processor or server.

The example camera system disclosed herein enables substantially all products on store shelves to be monitored while at the same time being relatively inconspicuous to consumers. By placing camera modules and tube sections on top of store shelving such that the cameras and tube-shaped objects are positioned to extend along a length of the shelving, a single row of cameras can monitor substantially all products on opposing shelving.

The positioning of the camera system on top (or in a mid-section) of store shelves enables product manufactures to monitor their products on store shelves in real-time. This real-time monitoring may help product manufactures determine, for example, locations on store shelves that cause additional sales of their product, effects of advertising campaigns, or effects of product packaging. This real-time monitoring may also be used to determine, for example, consumer purchasing decisions based on time period, demographic information as discernible from the images, etc.

The real-time monitoring may also be used for inventory control. For instance, a retailer may use the camera system to determine which products need to be restocked and/or reordered. Additionally or alternatively, a server in communication with the camera system may be configured to detect when products need to be restocked and/or reordered. The server may also be configured to predict when products will need to be reordered based on how quickly consumers are selecting a product.

Further, a relatively thin profile of the camera modules and tube-shaped objects enables the camera system to visually blend with shelves and other elements of a store. For instance, may stores arrange store aisles such that shelving, signage, and other store elements are parallel with each other to reduce the appearance of clutter and provide visually clean shopping lanes. As a result, security cameras are typically located close to ceilings, which are generally outside the view of customers. However, this placement results in limited views of products on shelves because the cameras are positioned to track consumers, not products. The low profile of the camera system disclosed herein enables numerous cameras to be deployed within a store to provide monitoring of substantial all store products while at the same time not interfering with a consumer's view of store aisles.

The low profile of the camera system also reduces consumer stress from constantly being monitored. Many consumers are weary of being monitored either in public or private settings. Cameras in plain view may cause consumers to move quickly through store aisles to minimize their time on camera. The example camera system disclosed herein reduces customer camera anxiety by being relatively unnoticeable while at the same time providing substantial product coverage. The example camera system accordingly enables products (and consumers) to be recorded as though the consumers were unaware of the recording.

While the figures described herein show diagrams of a circular cylindrical tube section and camera module, in other embodiments, the tube-shaped objects and camera module can include an elliptical cylindrical shape, or an oblique cylindrical shape. In yet other embodiments, the tube section and camera module can include a rectangular, triangular, pentagonal, hexagonal, etc. cross-sectional shape. Further, while the tube-shaped objects and the camera module are shown as having a 1.5 inch diameter, in other examples the tube-shaped objects and/or camera module can have a smaller or larger diameter.

Further, while the embodiments show a camera system implemented within a grocery store, it should be appreciated that the camera system could be implemented within any type of retail or consumer monitoring environment. For instance, the camera system could be implemented within hardware stores, department stores, appliance stores, electronic stores, pharmacies, etc. In addition, the camera system could be implemented within bars, restaurants, museums, transportation stations, or any other location where objects (or people) are to be monitored.

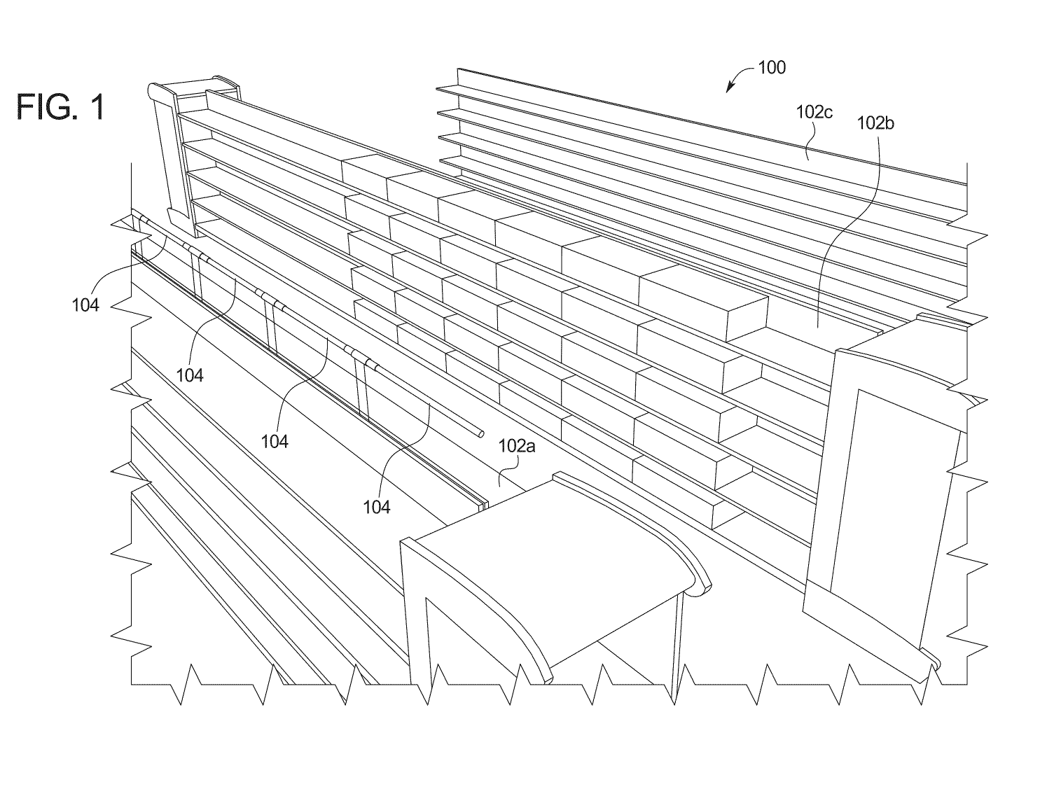

FIG. 1 shows a diagram of an in-store monitoring environment 100 that includes store shelves 102 (e.g., retail store shelving units), which are arranged in parallel rows to define aisles. For instance, store shelves 102a and 102b define an aisle therebetween. In the illustrated example, each of the store shelves 102 includes five rows of product shelving. In other embodiments, the store shelves 102 can include additional or fewer rows of product shelving. Here, store shelf 102a is attached to a camera system 104 that includes tube sections (e.g., tube-shaped objects) and camera modules. The camera system 104 is connected to a top center portion of the store shelf 102a. The positioning of the camera system 104 enables camera modules to monitor products on opposing store shelves including store shelf 102b to the right of store shelf 102a and a store shelf (not shown) to the left of store shelf 102a. In other embodiments, each of the store shelves 102a, 102b, and 102c include a respective camera system 104.

The individual camera modules are positioned within the camera system 104 such that the cameras monitor overlapping areas of an opposing shelf. This enables substantially all products on a store shelf to be monitored and images of an entire shelf to be combined or stitched together. The combined image is larger than the field of view provided by only one camera module, thereby enabling third parties to view entire aisles of products in a single image.

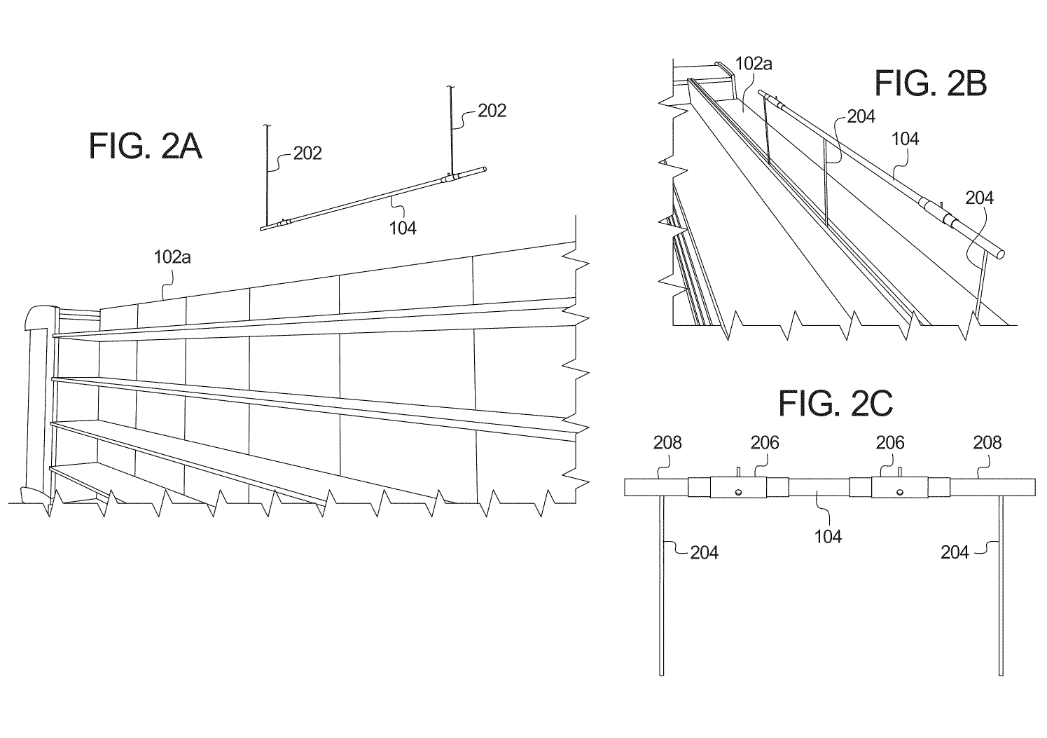

FIGS. 2A and 2B show diagrams of embodiments as to how the camera system 104 of FIG. 1 is supported within the monitoring environment 100. FIG. 2A shows a diagram where the camera system 104 is connected to a ceiling of the monitoring environment 100 via two supports 202. FIG. 2B shows a diagram where the camera system 104 is connected to a top center portion of a store shelf 102a via two leg sections 204. FIG. 2C shows a front-perspective view of the camera system 104 of FIG. 2B.

In these embodiments, the leg sections 204 and/or supports may also include electrical connections that facilitate the transmission of power and/or data to camera modules. For instance, the supports may themselves provide an electrical connection where a first support is connected to a ground potential and a second support is connected to a positive voltage potential. In other instances, electrical and/or communication wires may be routed through the supports and/or leg sections to a power supply, router, server, computer, processor, etc.

The embodiments shown in FIGS. 2A to 2C show a single camera system 104 including two camera modules 206 connected to tube sections 208. In other embodiments, the camera system 104 may include addition camera modules and/or tube sections mounted in-line adjacent to the shown camera modules 206 to form an extended row of camera modules. In some embodiments, some camera modules in a row may be supported from the ceiling while other camera modules in the same row are connected to the top of the store shelf. Further, while the camera systems 104 are shown as being supported by two leg sections or supports, in other embodiments the camera systems may be supported by fewer or additional leg sections or supports. For example, the camera system 104 shown in FIGS. 2B and 2C may include only a single leg section positioned at an end or in the middle of the system. Additionally, while the leg sections and supports are shown as being connected perpendicularly to the tube sections of camera systems 104, in other embodiments the leg sections or supports may be connected at an angle to the structures.

In yet alternative embodiments, the camera systems 104 may be mounted along one of the product shelves and/or at ground level of the shelf 102. For instance, instead of being mounted above the store shelf 102a, the camera system 104 may be mounted on a front edge of a product shelf or at the base of the product shelf. The camera system may be mounted on the front edge of the shelf in instances where there is limited room between the top of the product shelf and the ceiling.

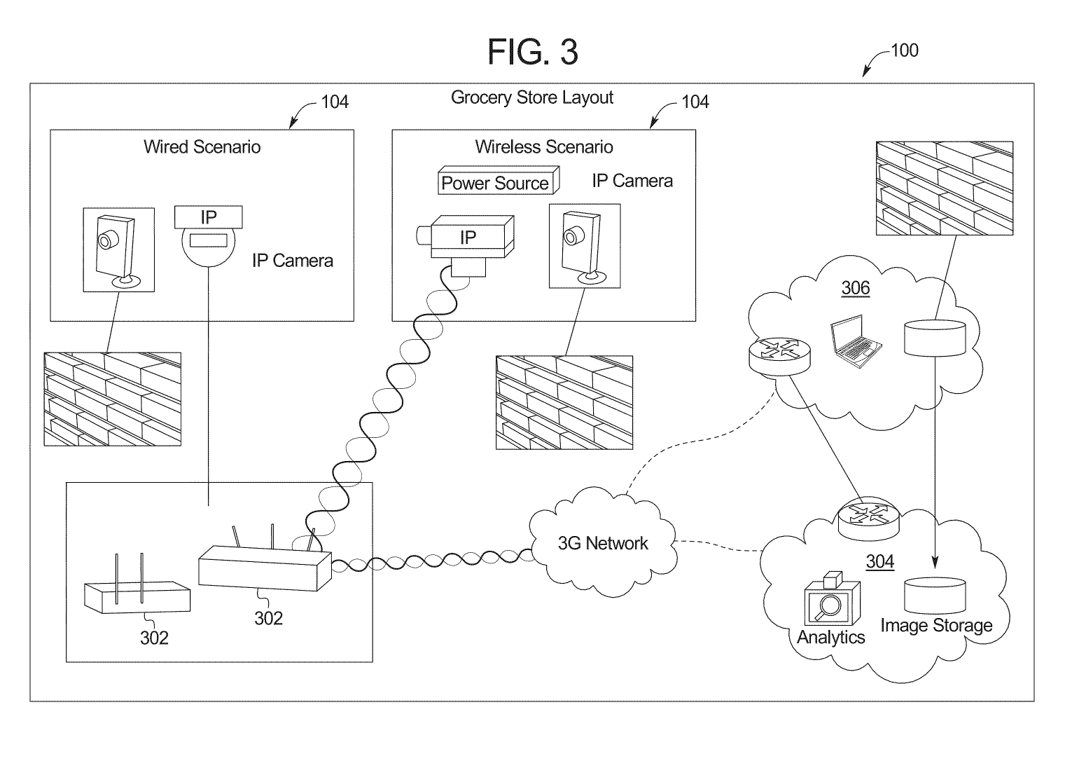

FIG. 3 shows a diagram of a system implementation of the monitoring environment 100 of FIG. 1. The system implementation includes a wired scenario and a wireless scenario. In the wired scenario, camera modules of camera system 104 receive power and communicate data via one or more wires. In the wireless scenario, camera modules of camera system 104 receive power from an electrically coupled power source and communicate data wirelessly with one or more wireless routers or access points 302. The camera system 104 may receive power from any type of power source (e.g., battery, power line, self generation) and communicate via any wireless and/or wired communication protocol (e.g., IEEE 802.11).

The camera systems 104 are communicatively coupled to one or more routers, access points, servers, processors etc. based on a store layout and/or configuration. The routers, access points, servers, processors may be connected to a management center 304 (e.g., a Scopix management center) and/or to a third party 306 (e.g., a product manufacturer) via any network (e.g., the Internet). In some examples, a server located within a store may communicate data between camera systems and a third party and/or management center 306 via one or more virtual private networks. In some instances, the server may stream data from the camera systems to the management center 304 and/or the third party 306. In other instances, the server may provide data upon request or at periodic time periods. The data can include recorded video data, image data, sensor data (e.g., temperature, humidity, luminosity of the monitored area, consumer count data, date/time information, demographic data, and/or an identifier of a camera that recorded an image/video). The data can also include messages from a server to one or more camera modules including, for example, messages instructing a camera to zoom, focus, pan, power-on, power-off, etc.

The example management center 306 includes, for example, one or more processors, servers, computers, etc. to process data from the camera modules 206 within the environment 100. In some embodiments, each instance of the monitoring environment 100 may include a local management center 306. In other words, each retail location may include a central processor to manage data from the local camera modules 206. Alternatively, the management center 306 may be centrally located with respect to multiple instances of monitoring environments 100 (e.g., located centrally for each type of retailer, each brand of retailer, each geographic location, etc.)

Data processing performed by the management center 306 can include, for instance, making data viewable to third parties, controlling camera zoom and tilt functions, monitoring camera diagnostics, performing consumer demographic/product recognition, and/or labeling visual data with product information. In particular, the management center 306 may include a data structure that references camera module identifiers (embedded and/or included with data from camera modules 206) with product identifiers of products being imaged by the respective camera module. Alternatively, the management center 306 may perform image recognition to identify products visually via packaging, bar codes, etc. The management center 306 stores or otherwise embeds the product identifiers as metadata of the visual data and/or links the product identifiers to the visual data.

A third party 306 may use data received from the camera systems to view in real-time products on a shelf. In some instances, the management center 304 may provide a third party access to only camera systems that are configured to image particular products (e.g., products produced by the third party or products provisioned to be monitored by the third party). The management center 304 may also obscure or otherwise blackout portions of video recorded by a camera system that are not authorized to be viewed by a third party. In this manner, the management center 304 prevents third parties from viewing competitor products. In addition, the management center 304 may enable third parties to send commends to camera systems to change settings or viewing parameters of the camera systems.

The example management center 304 may also store video and/or images provided by each of the camera modules. For instance, the management center 304 may configure one or more camera system(s) to provide an image every specified time period instead of receiving a video stream to reduce an amount of data transmitted. In other instances, the management center 304 may store video streamed by each camera module and make this video available to third parties 306.

In some instances, the management center 304 may combine images and/or video from adjacent cameras to stitch together a complete view of a store shelving unit. The stitching may be based on aligning images from cameras known to be adjacent to each other using camera identifies included with the data. In other examples, the stitching may be based on image or pattern recognition. The example management center 304 may also analyze the received data and compile reports for product manufacturers. The reports indicate, for example, average product time on a shelf, number of products sold over a time period, reactions to certain product packaging, etc.

In some embodiments, the management center 304 may include algorithms and/or processors configured to analyze video images and/or still images recorded by the camera modules to determine demographic characteristics of consumers. The management center 304 may also include algorithms and/or processors configured to correlate selection and/or viewing of products to particular demographic characteristics (e.g., gender, age, ethnicity, hair color, height, weight, clothing type, etc.). The management center 304 may generate reports for third parties including this correlation data.

The example management center 304 may further monitor the stock of products of shelves. For instance, the management center 304 may detect whether a product needs to be restocked on a shelf and send a message to the appropriate individual and/or retail location. The management center 304 may also predict when products will need to be restocked based on a frequency of consumer selection and send messages accordingly. In some instances, the management center 304 may be configured to order products (or indicate a time in the future when a product will be needed) from manufacturers and/or wholesalers responsive to detecting a product is to be restocked. The order can include a number of products to be provided at each store location.

It should be appreciated that the camera system 104 described herein enables third parties 306 to perform the functions described in conjunction with the management center 304. For example, a third party 306 may monitor how its products are selling in different retail locations and plan production based on anticipated restock orders from those retail locations. Additionally, a third party 306 may determine which retailers and/or retailers associated with a certain geographic location correspond to relatively higher product selection and adjust product planning based on this data.

Moreover, a third party 306 may use data from multiple systems in different retail locations to determine which physical location within a retail layout provides for improved product selection. In this instance, the management center 304 (or each camera system) may provide a layout map of each retailer that includes identifiers of a location of the camera system 104 and corresponding imaged products. Alternatively, the third party 306 may use an identifier of the camera system 104 and/or an identifier of a camera module 206 included within and/or provided in conjunction with the image data to determine a corresponding location on a previously provided or already generated layout map of the retail location. For example, image data associated with a soft drink includes an identifier of the camera module 206 that recorded the image. The third party 306 references this identifier to a specific physical location in the retail space based on a layout map that correlates identifiers to locations.

### Camera System

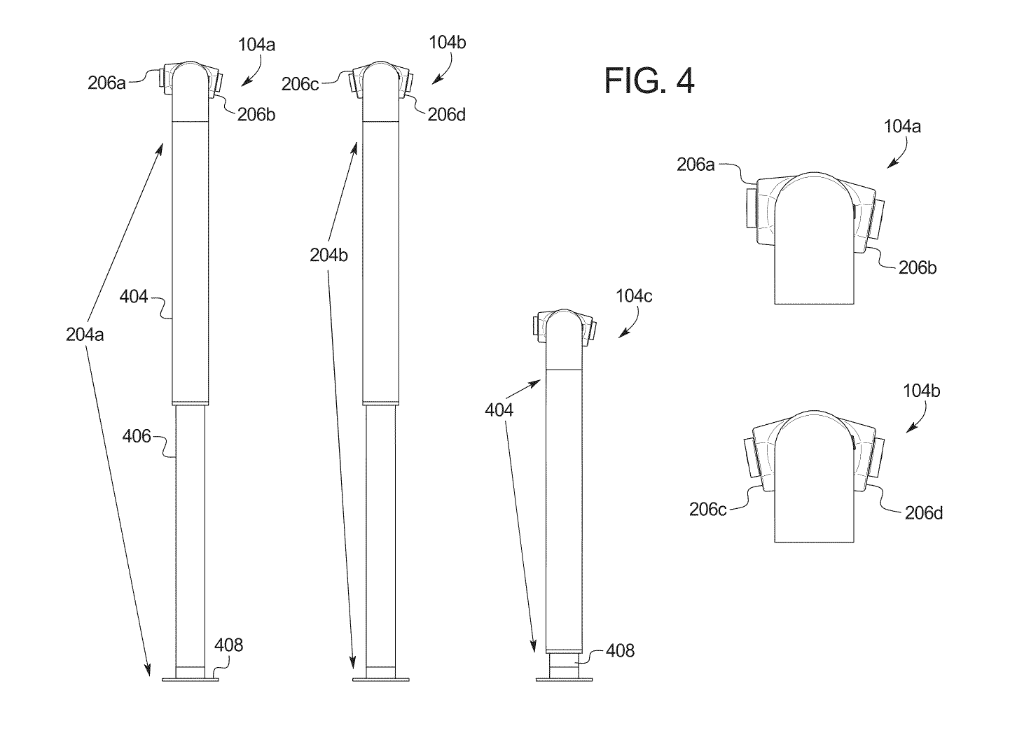

FIG. 4 shows a diagram of a side perspective view of the camera system 104 including leg sections 204. Camera systems 104a and 104b include an upper leg section 404, a lower leg section 406, and a base section 408. Camera system 104c includes only the upper leg section 404 and the base section 408. The camera systems 104a and 104b use the lower leg section 406 to extend the height at which the camera modules 206 are positioned above store shelves. In some embodiments, the lower leg section 406 may be retractable into the upper leg section 404 such that users may set a particular height of the camera system 104. The base section 408 enables the camera module 104 to be mechanically and/or chemically connected to store shelves.

The diagram of FIG. 4 also shows that the camera systems 104 can include camera modules facing opposite directions. For instance, camera module 104a includes a camera module 206a facing left and a camera module 206b facing right. FIG. 4 also shows that the camera modules 206a-d may be rotated to face different heights. For instance, in camera system 104a the camera module 206a is positioned for a lens to be relatively level while the camera module 206b is positioned for a lens to face downward. Additionally, in camera system 104b both camera modules 206c and 206d are positioned for respective lens to face downward.

The camera modules 206a-d may be positioned to focus on particular products and/or to accommodate different store layouts.

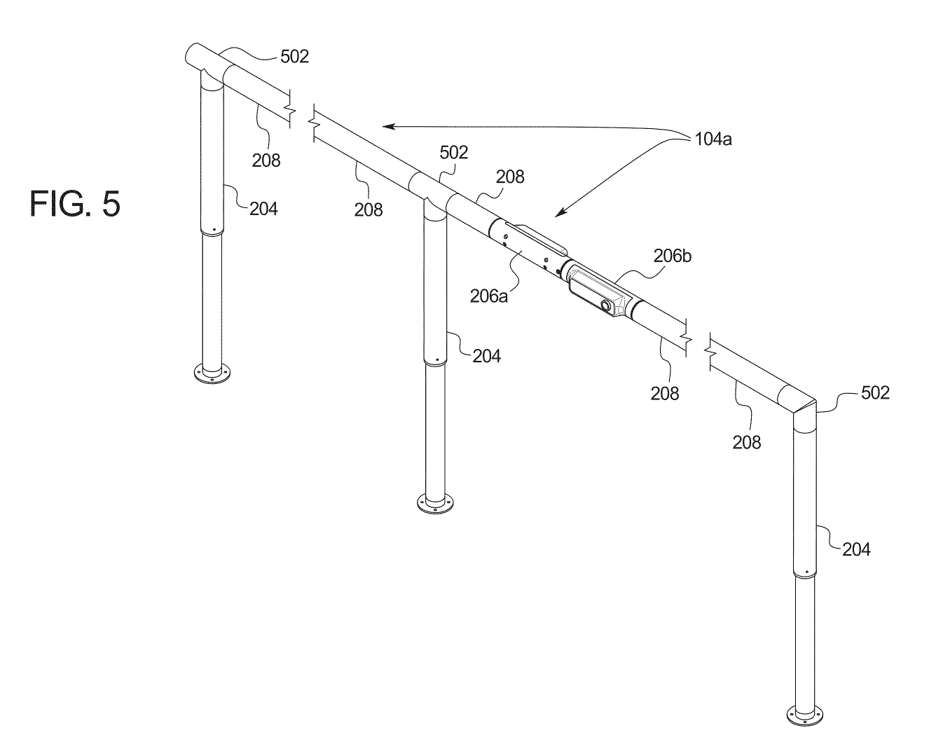

FIG. 5 shows a diagram of an angled perspective view of the camera system 104a of FIG. 4. In this example, the camera module 206a is connected in-line to camera module 206b. The camera modules 206a and 206b are connected in-line to tube sections 208, which are connected to leg sections 204 via joint sections 502. The camera modules 206 are positioned to face in opposite directions to enable monitoring of store shelves that are adjacent to the store shelf connected to the camera system 104a. As shown in FIG. 5, the camera modules 206 include diameters that are substantially equal to the diameters of tube sections 208 and joint sections 502. This provides a streamlined profile that reduces the conspicuousness of the camera system 104a within the monitoring environment 100. To accommodate all components needed to record and process images and/or video, the camera modules 206 are dimensioned to be an elongated tube shape. Further, camera lenses of the camera modules 206 are positioned to face a direction perpendicular to a direction of the length of the camera system 104a.

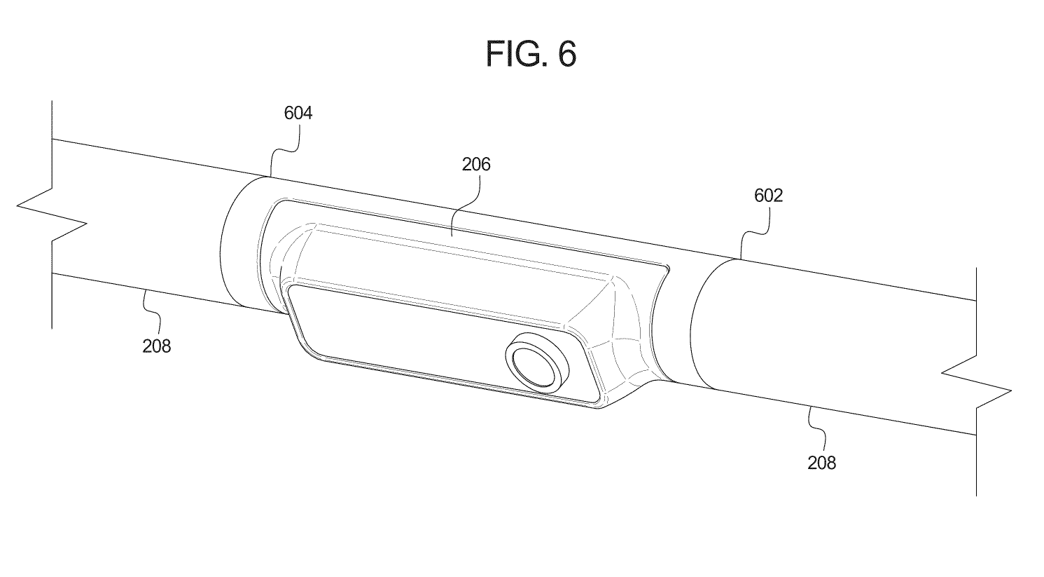

FIG. 6 shows a diagram of a camera module 206 connected to tube sections 208 at a first end and a second end. FIG. 6 shows that a housing of the camera module 206 is flush with the tube sections 208 to provide an appearance of a single continuous tube. While the camera module 206 is shown as being a different color than the tube sections 208, in other embodiments the camera module 206 can be the same color as the tube sections 208.

### Camera System Assembly

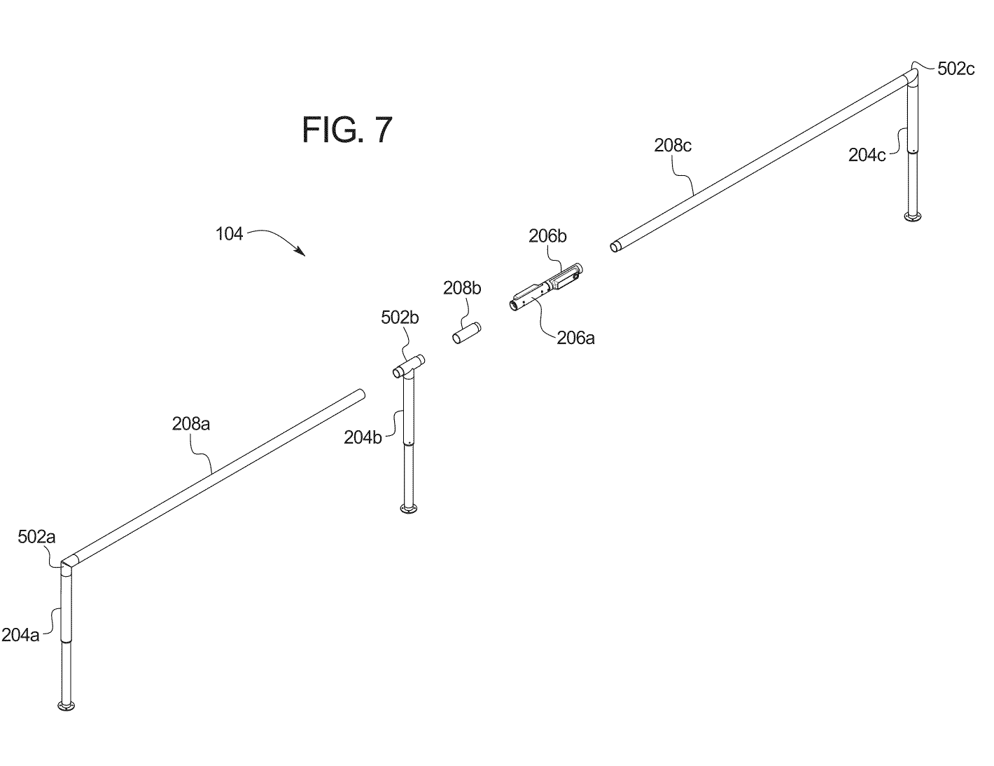

FIG. 7 shows a schematic diagram of an assembly of a camera system 104. In other embodiments, the camera system 104 can include different configurations of tube sections 502 intermixed with camera modules 206. For example, while FIG. 7 shows camera modules 206 connected directly together, in other examples the camera modules may be separated by one or more tube sections.

In the example embodiment shown in FIG. 7, leg sections 204a, 204b, 204c are connected to respective joint sections 502a, 502b, and 502c. The joint sections 502a and 502b are connected together via tube section 208a. Additionally, joint sections 502b and 502c are connected together via tube sections 208b and 208c and camera modules 206a and 206b. It should be appreciated that FIG. 7 shows that joint sections can be connected together without having a camera module in between. It should also be appreciated that the lengths of tube sections 208a-c are arbitrary and may vary depending on desired positioning of camera modules 206 within the camera system 104.

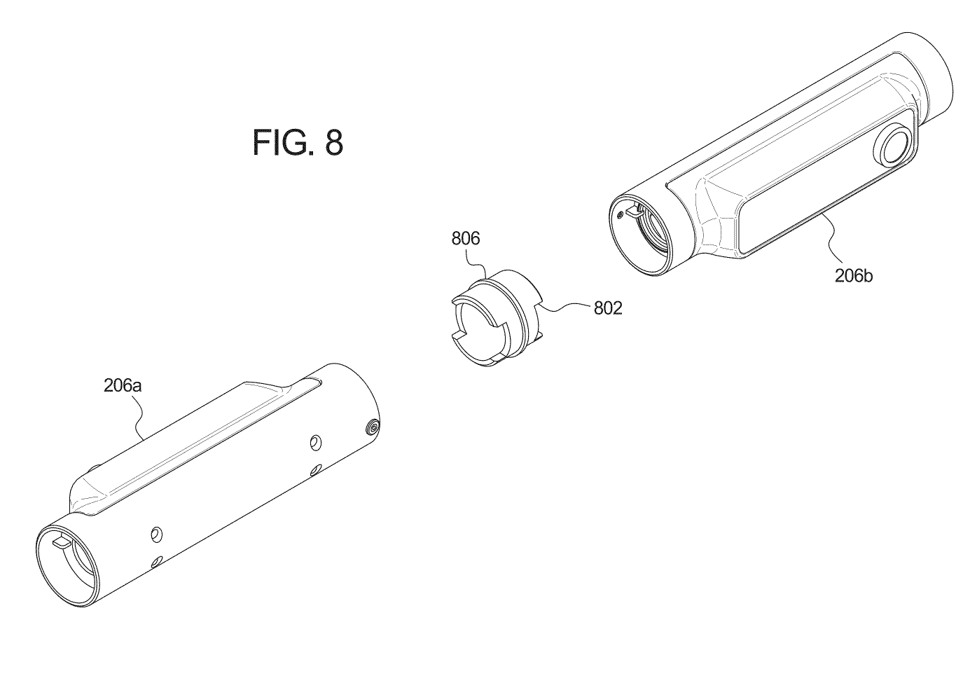

FIG. 8 shows a schematic diagram of an assembly of two camera modules 206. In FIG. 7, camera modules 206a and 206b were shown as being connected together. FIG. 8 in contrast shows that the camera modules 206a and 206b may be connected together via a camera module connector 802. In this embodiment, the camera modules 206 include ends that are configured to accommodate a portion of the connector 802. In addition, the ends of the modules 206 may include screw hole that enables the ends of the camera modules 206 to physically connected to the respective sides of the camera module connector 802.

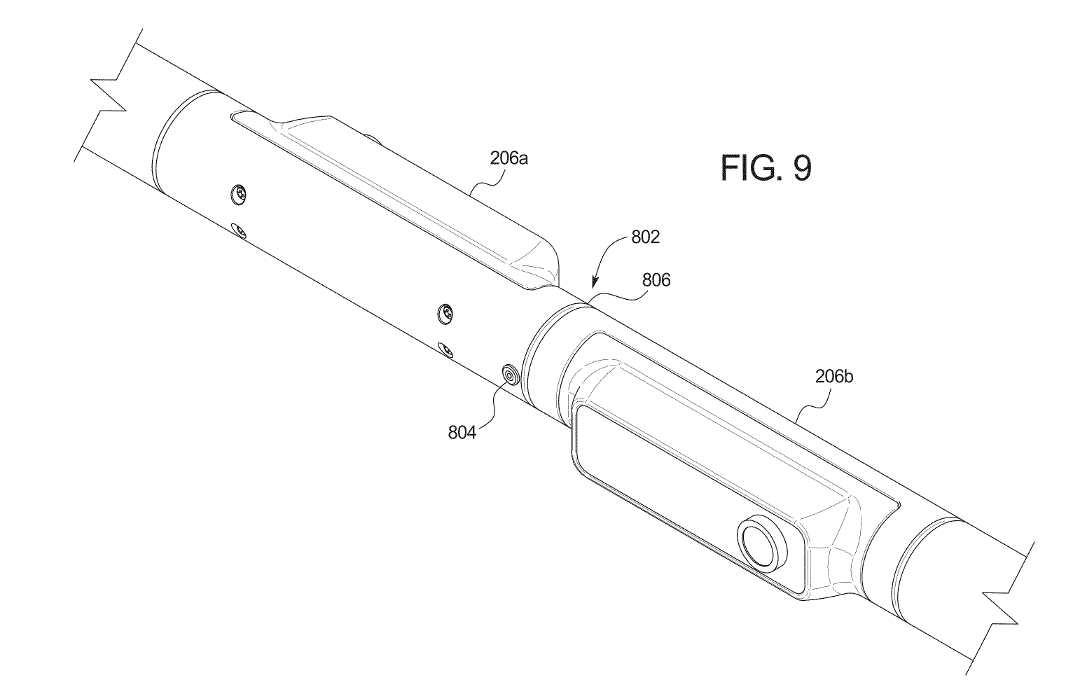

The example connector 802 is connected to the camera modules 206 by rotating the connector until a screw hole in the connector aligns with a corresponding screw hole in the module. A user may then insert a screw through the aligned screw holes to attach the connector 802 to the camera module 206. FIG. 9 shows a screw hole 804 of camera module 206a with a screw inserted to attach the module to the connector 802. In other examples, the connector 802 and corresponding ends of the camera modules 206 may include features that enable the connector to snap into the end of the camera module. In further examples, a set screw may be attached to the connector 802 through a set screw hole located at an end of the camera module 206. The set screw enables the camera module 206 to be rotated in relation to the connector 802 because the set screw can be connected to any face portion of the connector 802.

It should be noted that the connector 802 includes a lip 806 that separates an end of camera module 206a from an opposing end of camera module 206b. The lip 806 may be substantially flush with ends of the camera modules 206a and 206b to provide the appearance of a continuous tube. In some alternative embodiments, the lip 806 may include a separator that enables the camera modules 206a to be individually rotated without affecting the positioning of the other camera module 206b. For example, the separator included within the connector 802 may enable a user to rotate camera module 206a upwards while rotating camera module 206b downwards.

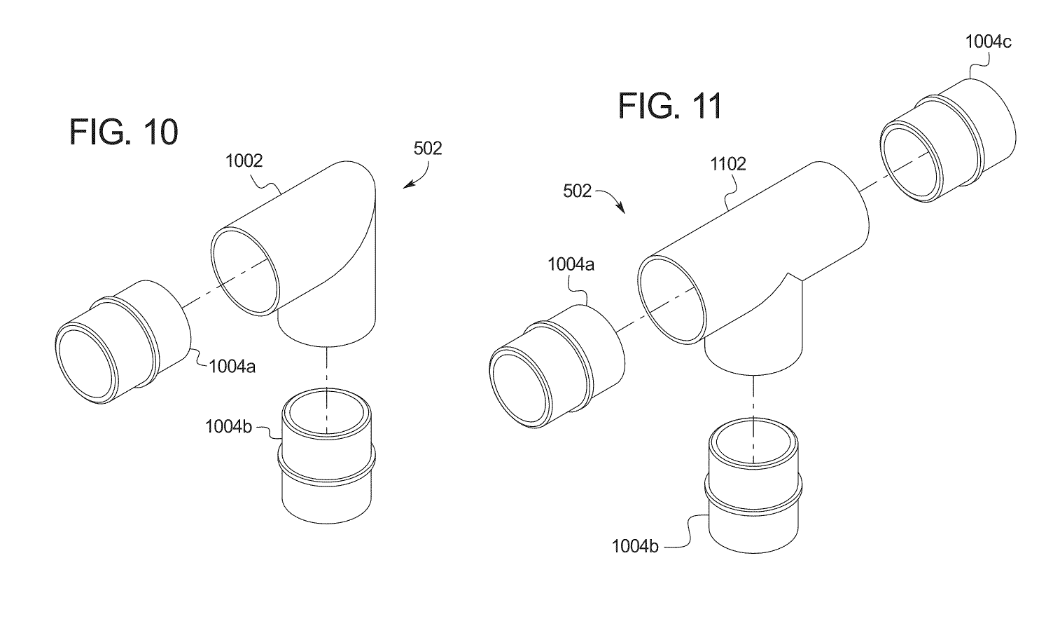

FIGS. 10 and 11 show schematic diagrams of joint sections 502. FIG. 10 shows an illustration of an L-shaped joint section 1002 and FIG. 11 shows an illustration of a T-shaped joint section 1102. The L-shaped joint section 1002 is used at ends of the camera system 104 while T-joint sections 1102 is used in the middle of the camera section 104. The joint sections 1002 and 1102 are connected to leg sections 204, tube sections 208, and/or camera modules 206 via joint connectors 1004a and 1004b. The T-shaped joint section 1102 additionally includes a third joint connector 1004c. The connections may be made using, for example, screws as described in conjunction with FIGS. 8 and 9. Alternatively, the joint connectors 1004a-c may connect to the joint part 502 and/or leg sections 204, tube sections 208, and/or camera modules 206 via chemical adhesives, mechanical fasteners, mechanical pressure, and/or snap connectors. In further alternative embodiments, the joint sections 1002 and 1102 may be integrated with the connectors 1004 to reduce the number of individual components of the camera system 104.

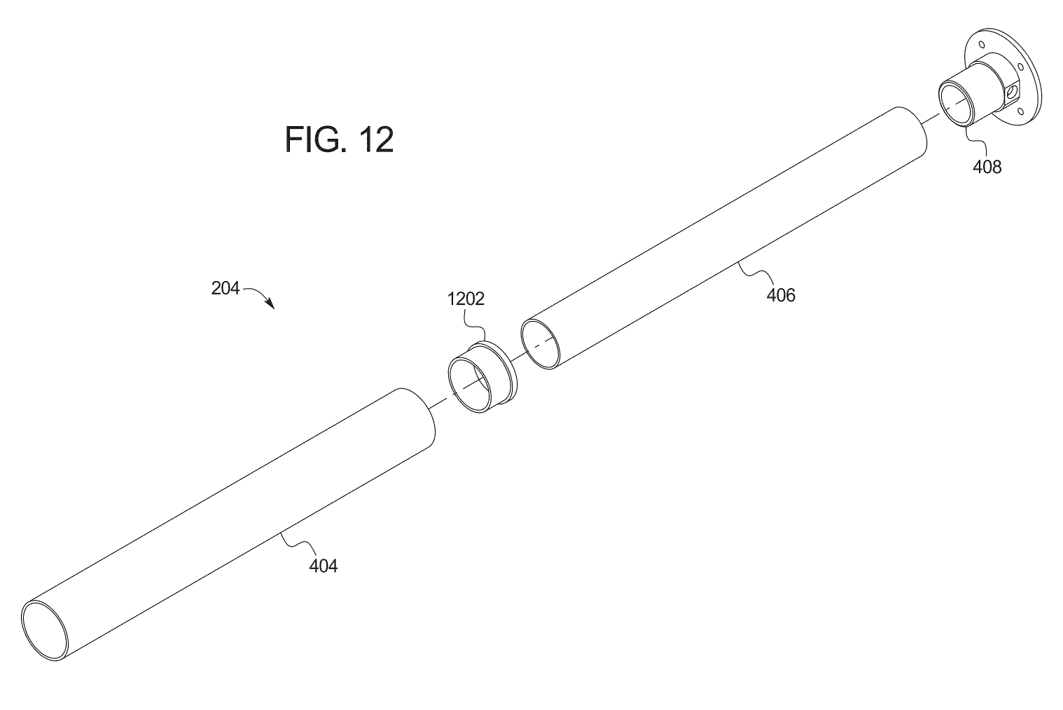

FIG. 12 shows a schematic diagram of an assembly of a leg section 204. The assembly includes the upper leg section 404, the lower leg section 406, and the base section 408. The assembly also includes leg connector 1202 that connects the upper leg section 404 with the lower leg section 406. Similar to the connectors described in conjunction with FIGS. 8 to 11, the connector 1202 may be attached to the leg sections 404 and 406 via chemical fasteners, pressure, and/or mechanical fasteners.

In some embodiments, the leg connector 1202 enables the lower leg section 406 to be retracted into the upper leg section 404 to adjust a height of the leg section 204. For instance, the connector 1202 may be rotated to relieve pressure against the lower leg section 406, thereby enabling it to be extended from or retracted into the upper leg section 404. The connector 1202 may then be rotated in an opposite direction causing pressure to be applied to the lower leg section 406 resulting in the lower leg section locking into place with the upper leg section 404. In examples, where the lower leg section 406 is omitted, the upper leg section 404 is attached directly to the base section 408. In alternative embodiments, the leg connector 1202 may be integrated with any of the leg sections 404 and 406 and/or the base section 408.

### Camera Module

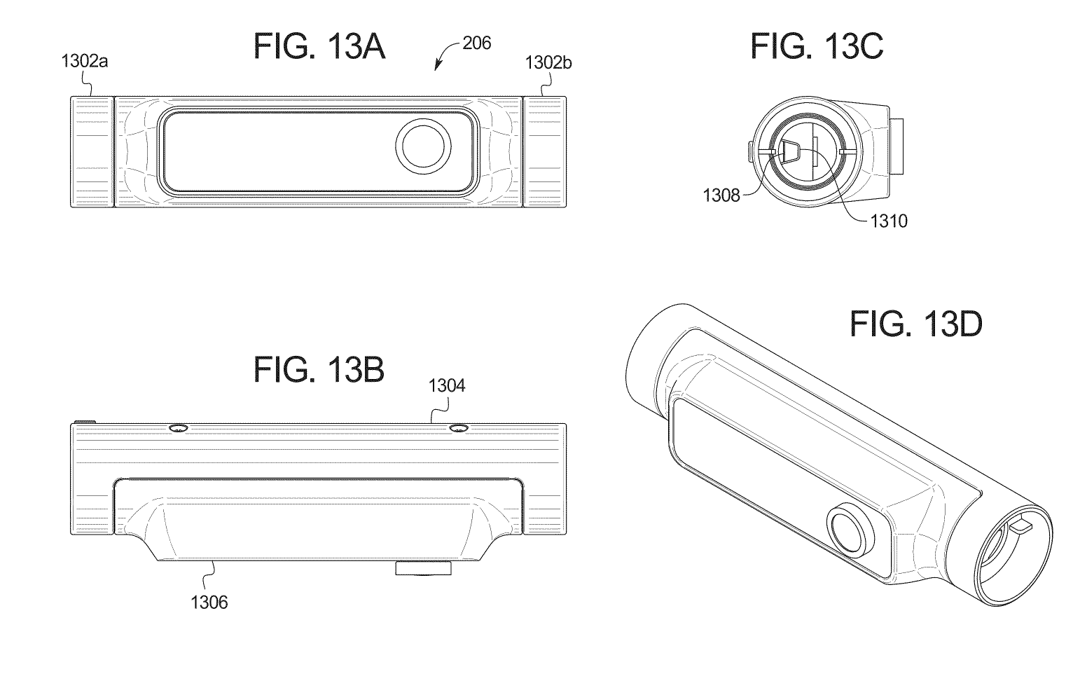

FIGS. 13A to 28 show schematic diagrams of the camera module 206. In particular, FIGS. 13A to 13D show different perspective views of an assembled camera module 206. FIG. 13A shows a diagram of a front perspective view, FIG. 13B shows a diagram of a side perspective view, FIG. 13C shows a diagram of an end perspective view, and FIG. 13D shows a diagram of an angled-side perspective view of the camera module 206.

The camera module 206 includes first and second ends 1302a and 1302b that are configured to be connected to tube sections 208 or other camera modules. The ends 1302 include diameters that are substantially equal to diameters of tube sections such that the camera module 206 appears as a continuous tube or pipe.

FIG. 13B shows that camera module 206 includes a back housing 1304 (e.g., a camera seat portion) and a front housing 1306 (e.g., a camera housing). In the illustrated embodiment, the back housing 1304 is integrally connected to portions of the ends 1302 so as to form an opening to accommodate the front housing 1306. The back housing 1304 has a diameter that is substantially equal to diameters of the ends 1302 and the tube sections 1302 such that the camera module 206 appears as a continuous tube.

The front housing 1306 is connectable to the back housing 1304 and is shaped to fill the opening provided by the back housing 1304 and the ends 1302 such that edges of the front housing 1306 are substantially flush with the ends 1302 and the back housing 1304. The front housing 1306 includes the camera and components to operate the camera. To accommodate the camera, portions of the front housing 1306 extend outward from the edges of the housing. The amount of the extension is based on the dimensions and types of camera components used. In some embodiments, the front housing 1306 may not include the extension so that the combination of the front housing 1306 and the back housing 1304 has a diameter substantially similar to the diameter of the tube section 208, further streamlining the profile of the camera system 104.

In some instances, the camera housing 1306 may be replaced with a ‘dummy’ housing that does not include a camera. The dummy housing provides a cover for the opening of the back housing 1304 in instances where a camera may be attached to the back housing 1304 at a later time. The dummy housing may have an appearance similar to the tube section 208 or, alternatively, an appearance similar to the camera housing 1306.

FIG. 13C shows electrical connectors 1308 and 1310. In this embodiment, the connector 1308 facilitates the transfer of data and the connector 1310 facilitates the transfer of power. The connectors 1308 and 1310 are disposed within the ends 1302 such that they are aligned to connect to respective electrical connectors within tube sections 208, other camera modules 206, and/or camera module connectors 802. For instance the tube sections 208, joint sections 502, leg sections 204, and/or base sections 408 may include connectors and/or wiring to facilitate the transfer of data and/or power through the camera system 104 to the camera module 206.

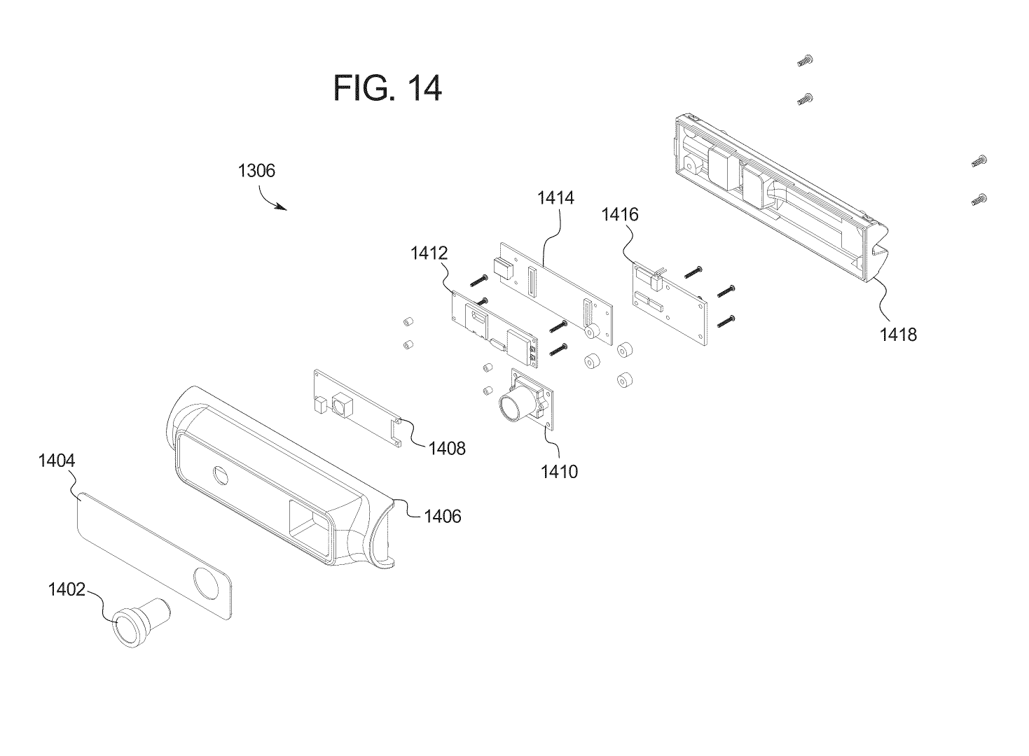

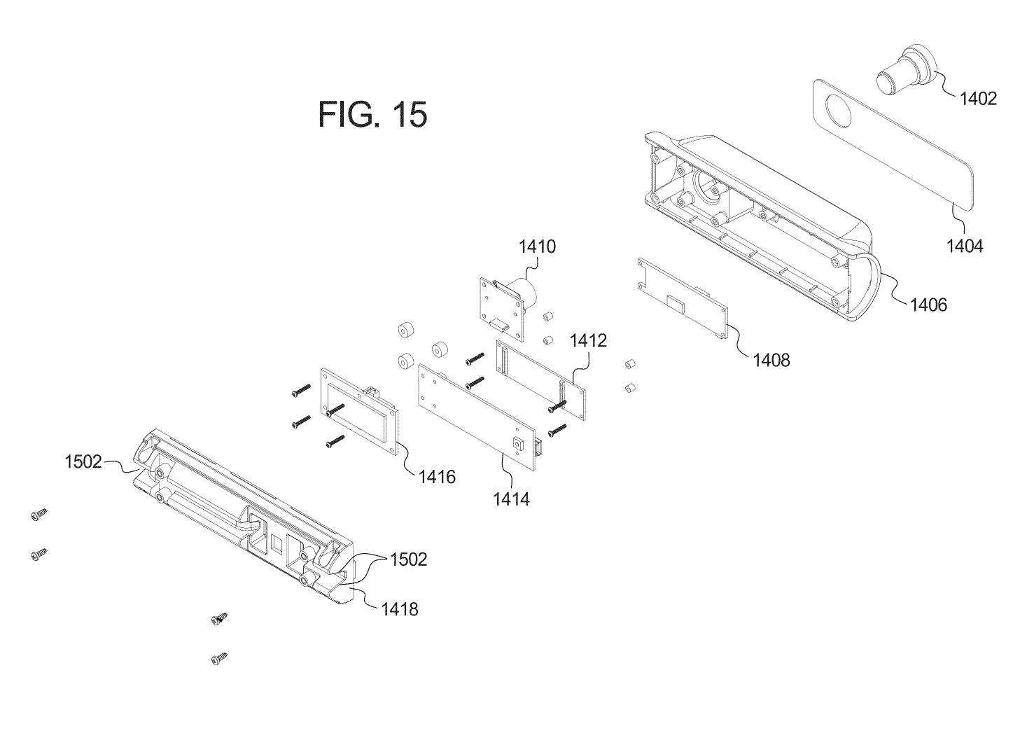

FIGS. 14 and 15 show diagrams of exploded views of the front housing 1306 of camera module 206. In particular, FIG. 14 shows a front-perspective exploded view and FIG. 15 shows a rear-perspective exploded view. The front housing 1306 shown in FIGS. 14 and 15 is only one possible embodiment. In other embodiments, the front housing 1306 can include additional or fewer components. For instance, the front housing 1306 could also include thermal imaging sensors or motion detection sensors. Additionally, the components may be arranged differently based on dimensions of the camera module 206.

In the example embodiment shown in FIGS. 14 and 15, the front housing 1306 includes a camera lens 1402, a front mask 1404, a front case 1406, an image support circuit board 1408, a photo detector (e.g., camera) 1410, a control circuit board 1412, a communication circuit board 1414, a connector circuit board 1416, and a rear case 1416. The camera lens 1402 includes any type of lens that provides zoom and focusing functions. The front mask 1404 provides light diffusion for a flash included on the image support circuit board 1408. In other examples, the front mask 1404 may include an opening for a view finder lens included on the image support circuit board 1408.

The photo detector 1410 comprises any type of photo detector including a video camera, a high-definition camera, an infrared camera, a thermal camera, or a three-dimensional camera. The photo detector 1410 is controlled by microcontrollers and/or processors on the control circuit board 1412. For instance, processors on the control circuit board 1412 may provide instructions changing a zoom/focus of the lens 1402 and/or instructions indicating when the photo detector 1410 is to record an image or video. The control circuit board 1412 may also time-stamp recorded images and video with a time/date in which the data was recorded. Further, the control circuit board 1412 may embed metadata with the recorded images/video to provide an identification number of the camera module 206, for example. The control circuit board 1412 may also convert data recorded by the photo detector 1410 into a format for transmission to a computer or server. Additionally, the control circuit board 1412 may also include memory for storing instructions to operate the photo detector 1410 and/or for storing recorded images and/or video.

The example communication circuit board 1414 includes processors or controllers to facilitate communication between processors on the control circuit board and a separately located computer or server. For instance, the communication circuit board 1414 may format data for transmission across a local area network or a virtual private network. In embodiments where the camera module 206 is to include wireless capability, the communication circuit board 1414 includes wireless transceivers to communicate with wireless routers, access points, or servers.

The example connector circuit board 1416 includes one or more electrical connectors configured to attach to corresponding connectors within the rear housing 1304. The electrical connectors can include connectors to facilitate power transfer and/or data transfer. The connector circuit board 1416 also includes power regulators to provide a regulated voltage to the photo detector 1410, the flash on the image support circuit board 1408, and processing components on the control circuit board 1412 and the communication circuit board 1414.

The example rear case 1418 is connected to the front case 1406 so as to enclose the components 1408 to 1416. The front case 1406 has a diameter that is substantially equal to diameters of the ends 1302 and the rear housing 1304 such that edges of the front case 1406 are flush with the ends 1302 and the rear housing 1304 when the front housing 1306 is installed. The rear case 1418 includes features to connect the front housing 1306 to the rear housing 1304. For instance, FIG. 15 shows that the rear case 1418 includes a pair of notch connectors 1502 at either end to attach to corresponding connectors in the rear housing 1304. The shape of the notch connector 1502 enables the front housing 1306 to be snapped into the rear housing 1304 without additional connectors. However, in some embodiments, screws may also attach the rear housing 1304 to the front housing 1306. The notch connectors 1502 also guide the front housing 1304 into the rear housing 1306 such that corresponding electrical connectors are properly connected.

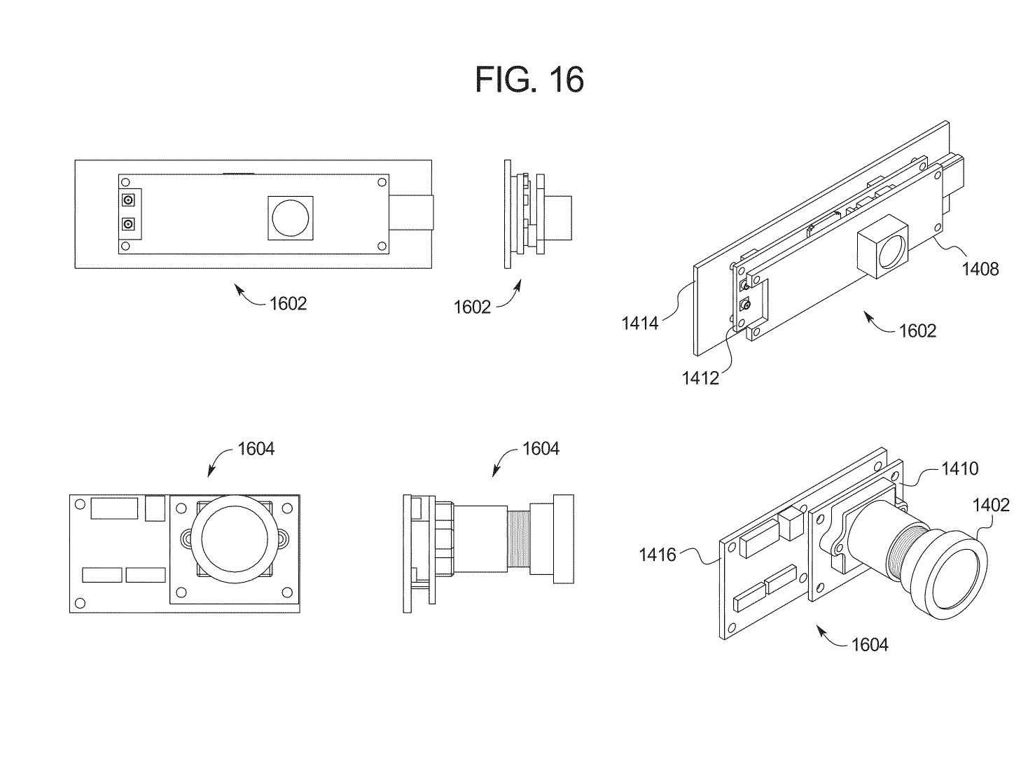

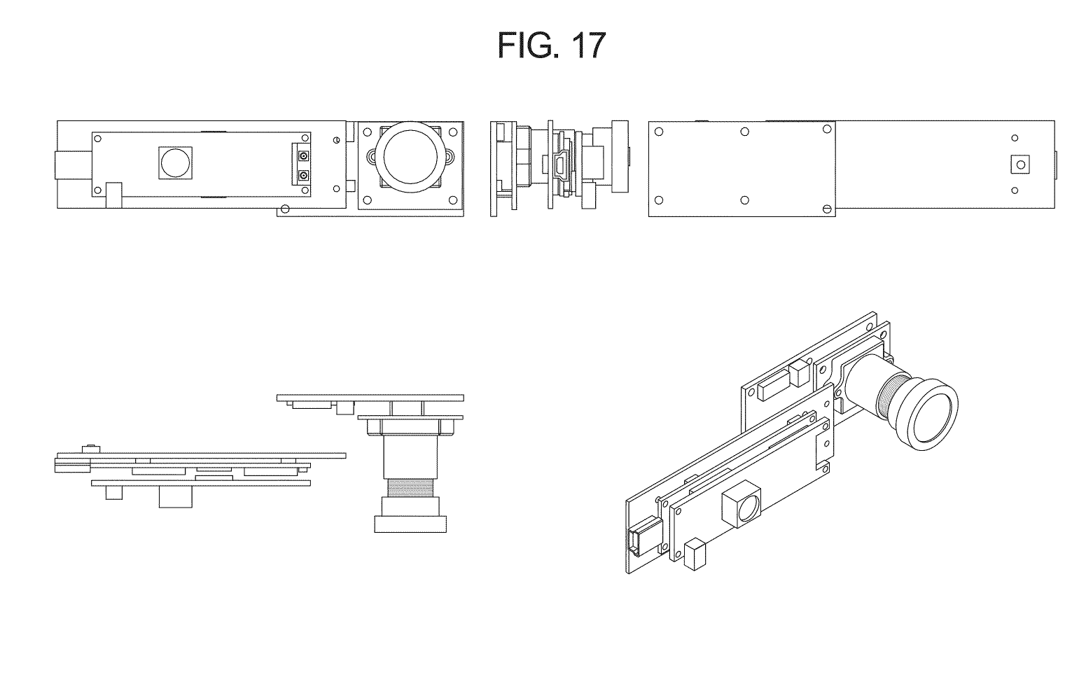

FIGS. 16 to 19 show different perspective views of assemblies of the circuit boards 1408, 1412, 1414, and 1416 with the photo detector 1410 and the camera lens 1402. For instance, in FIG. 16, the circuit boards 1408, 1412, and 1414 are connected together via inter-board connectors to form a first assembly 1602. Additionally, FIG. 16 shows that the photo detector 1410 is connected to the connector circuit board 1416 and camera lens 1402 via inter-board connectors for form a second assembly 1604. In FIG. 17, the first assembly 1602 of circuit boards 1408, 1412, and 1414 is connected to the second assembly 1604 of the circuit board 1416, the photo detector 1410, and the camera lens 1402 to form a third assembly 1702. The dimensions shown in FIGS. 16 and 17 are examples and may change based on requirements, applications, and/or features of the camera module 206.

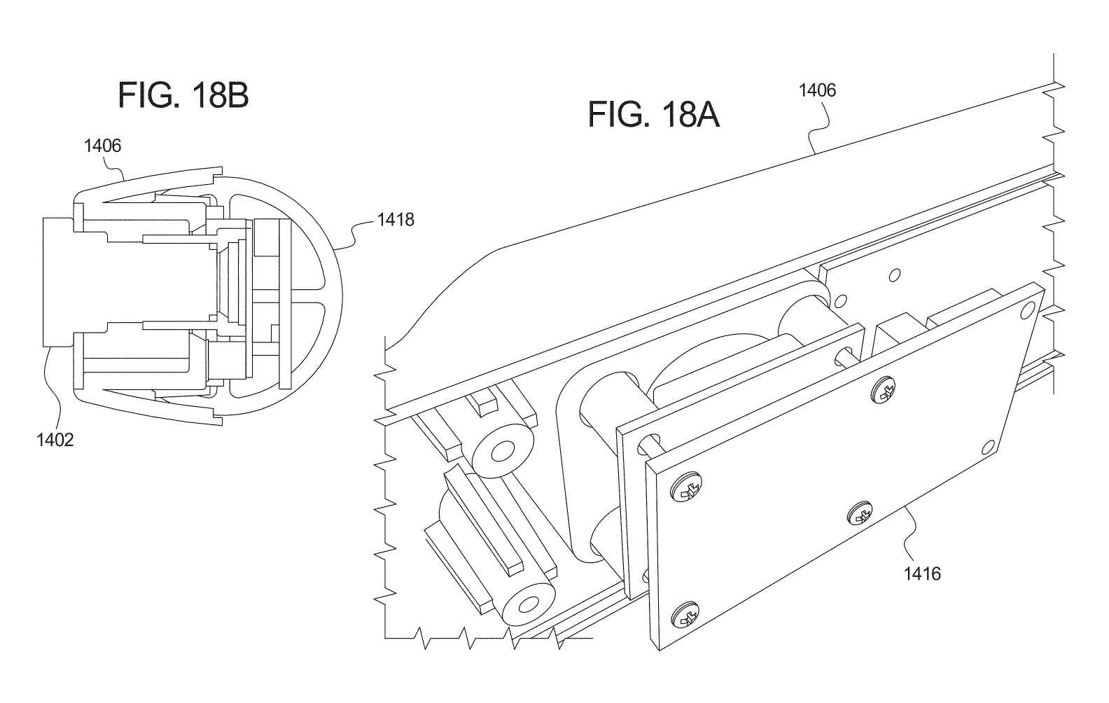

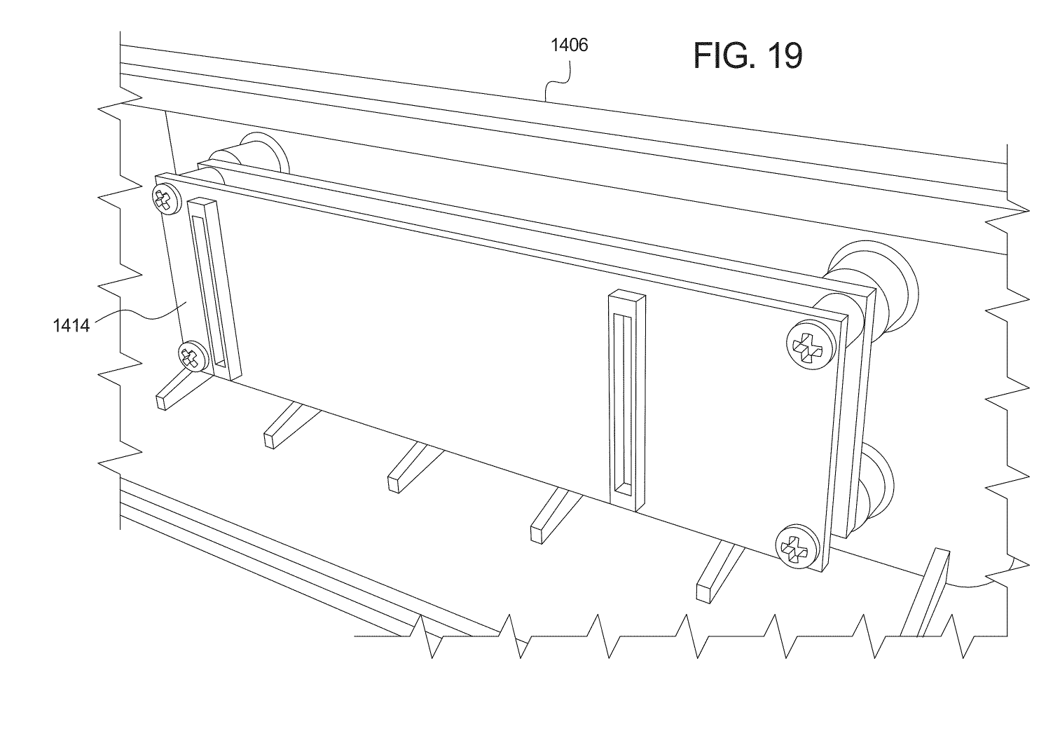

FIGS. 18A, 18B, and 19 show assemblies of the circuit boards of FIGS. 16 and 17 connected into the front case 1406 and the rear case 1418. In particular, FIGS. 18A and 19 show diagrams of the circuit board assemblies connected via mechanical fasteners (e.g., screws) to the front case 1406. FIGS. 18B shows a diagram of a cross-sectional view of the front housing 1306 including a depiction as to how the camera lens 1402 is disposed within the front case 1406. FIG. 18B also shows a depiction as to how the rear case 1418 is dimensioned to connect to a portion of the front case 1406 that is interior to an outer edge of the front case 1406.

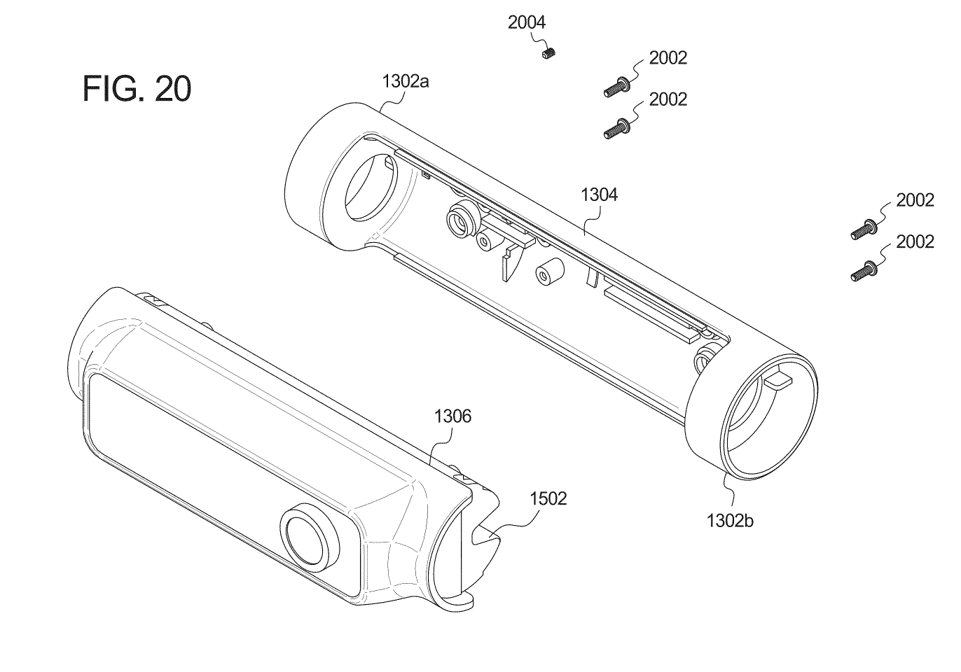

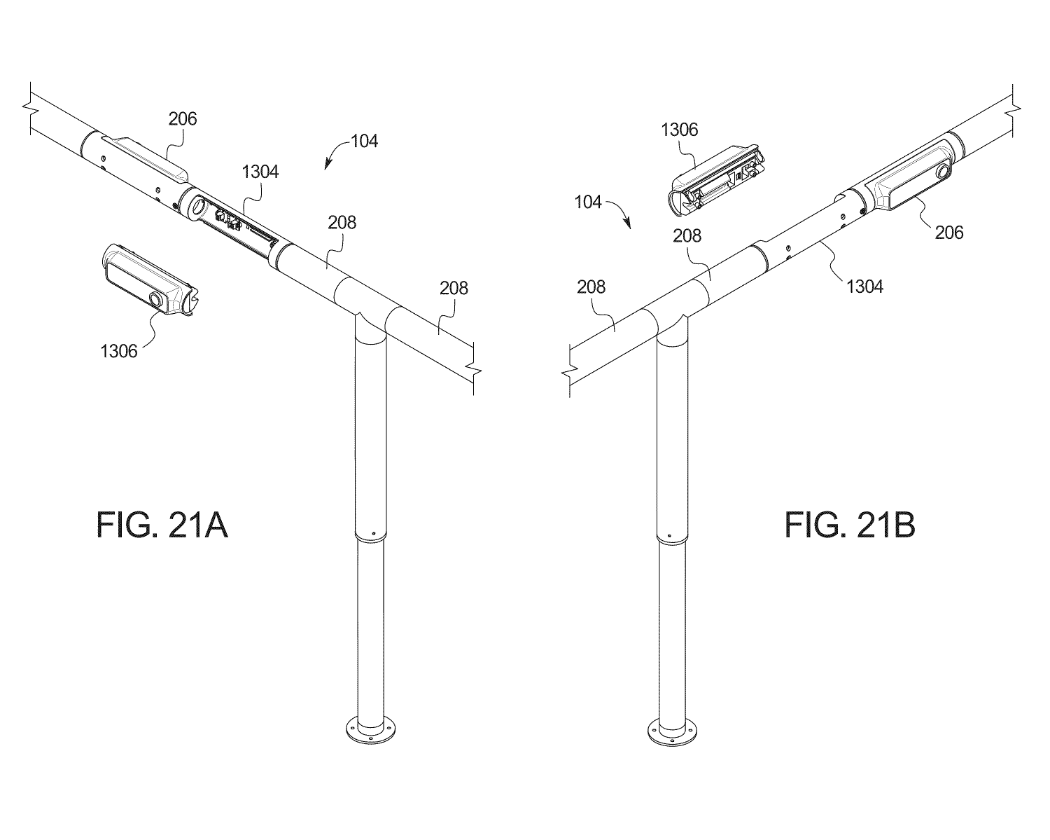

FIGS. 20, 21A, and 21B show diagrams of a complete assembly of the front housing 1306 prior to insertion into the rear housing 1304. As discussed above, the rear housing 1304 is integrally connected to portions of the ends 1302 so as to form an opening to accommodate the front housing 1306. The front housing 1306 is guided into the rear housing 1304 via the connectors 1502. Mechanical fasteners 2002 may then attach the rear housing 1304 to the front housing 1306. A set screw 2004 prevents the front housing 1306 from moving or rotating within the back housing 1304 after the front housing 1306 has been rotated or tilted to a desired position.

FIGS. 21A and 21B show diagrams of the front housing 1306 prior to connection to the rear housing 1304, which is already connected within a camera system 104. In particular, FIGS. 21A and 21B show that rear housings 1304 may be connected to tube sections 208 and/or other camera modules 206 to construct the camera system 104. After the rear housings 1304 have been secured, the respective front housings 1306 are attached. This configuration enables front housings 1306 to be replaced without having to disassemble the entire camera system 104.

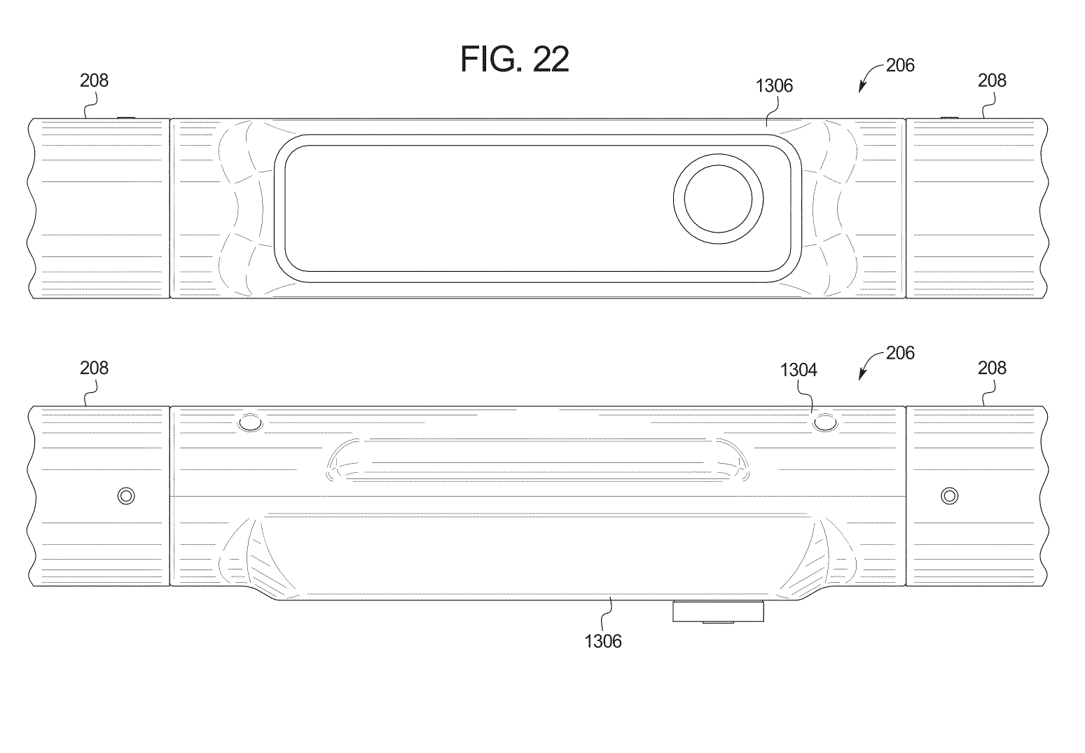

FIG. 22 shows a diagram of a front housing 1306 assembled with a rear housing 1304 to form the camera module 206. As shown, the front housing 1306 is connected to the rear housing 1306 such that an exterior casing is flush with tube sections 208 so as to give an appearance of a continuous tube. This configuration helps provide a relatively low profile camera system that is generally inconspicuous to consumers. It should be noted that the dimensions shown in FIG. 22 provide one example embodiment of the camera module 206. In other embodiments, the camera module 206 may be dimensioned differently based on application, function, or requirements.

Housing Electrical Connectors

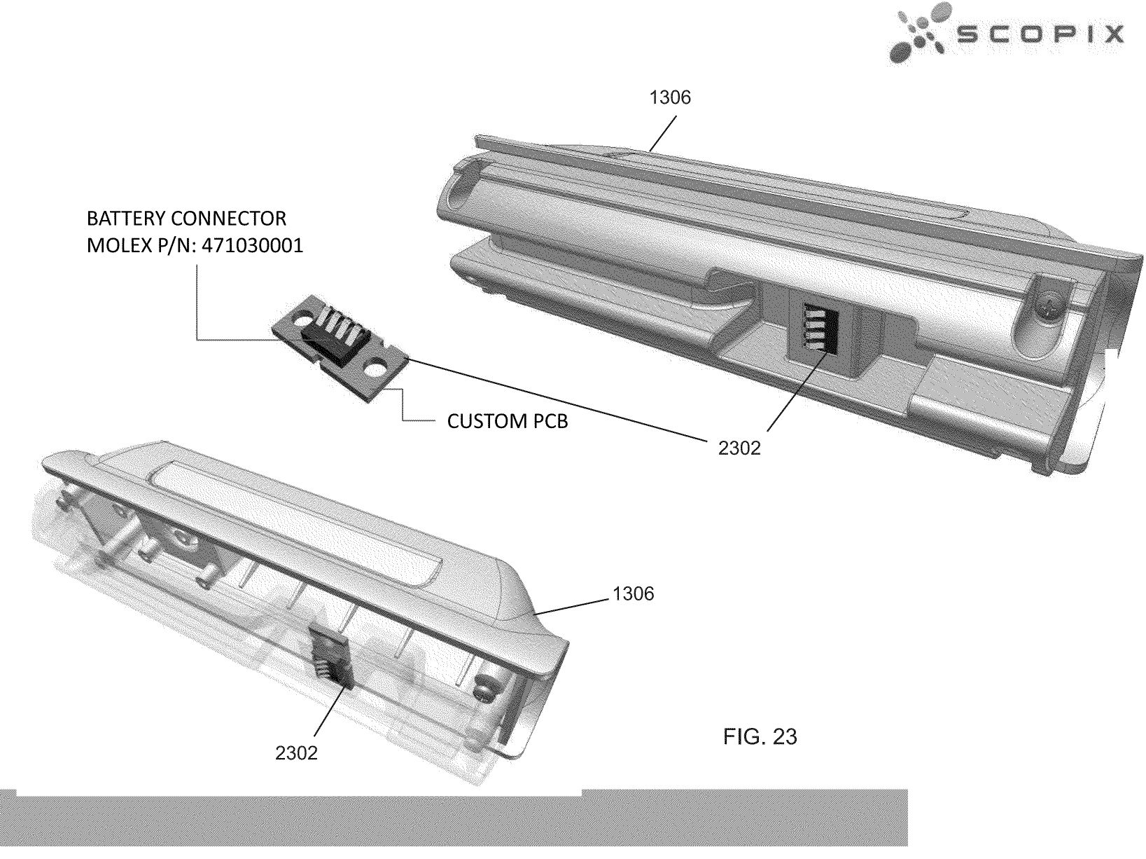

FIGS. 23 to 25 show diagrams of example electrical connectors configured to electrically couple the front housing 1306 to the rear housing 1304. In particular, FIG. 23 shows a diagram of an example power connector 2302, which connects to a corresponding connector in the rear housing 1304. The connector 2302 is connected to the connector circuit board 1416 and includes pins or leads that extend through a portion of the rear case 1418. In embodiments where the camera module 206 is to be connected via a wire to a separately located computer or server, the connector 2302 may also include pins designated for data. Alternatively, the rear housing 1304 may include a second opening for a separate data connector.

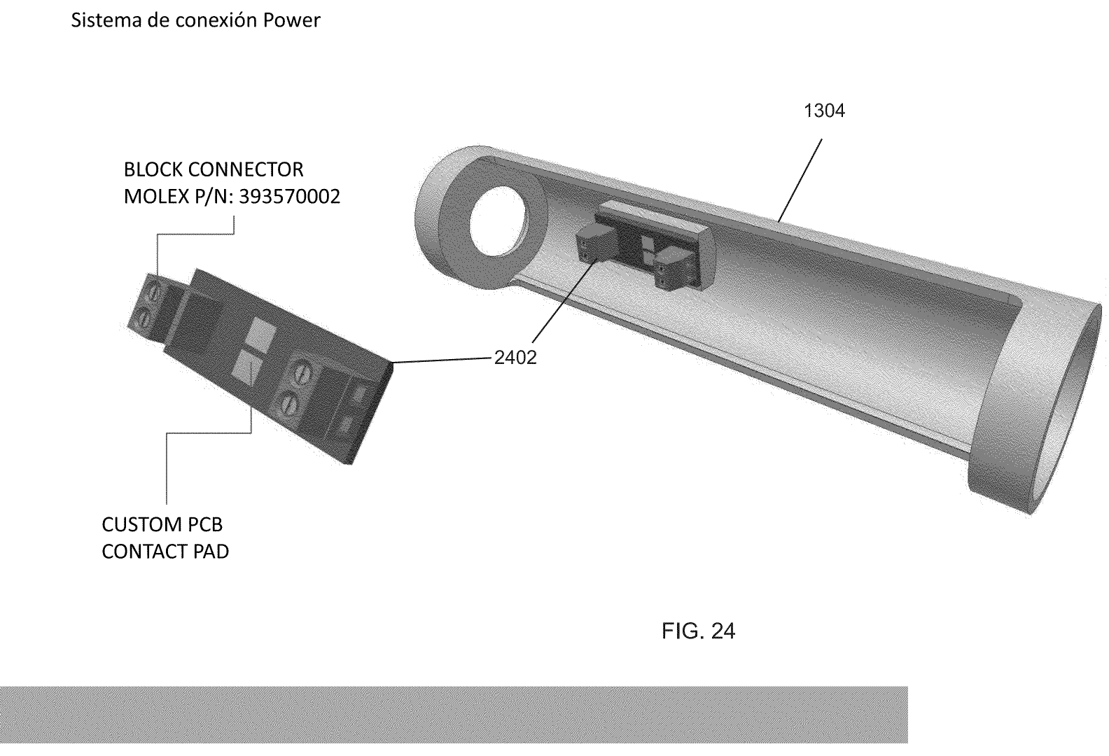

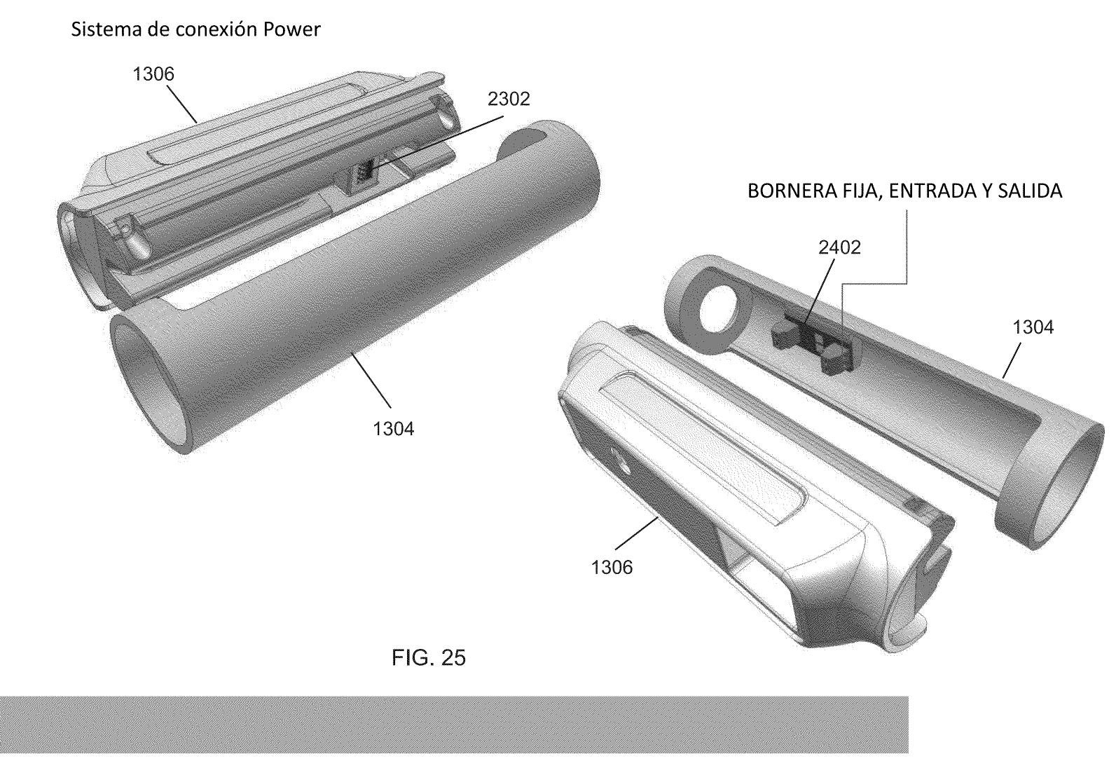

FIG. 24 shows a diagram of a connector 2402 in the rear housing 1304 that is configured to connect to the connector 2303 of FIG. 23. The connector 2402 includes printed circuit board pads that are configured to contact the pins or leads of the connector 2302, thereby establishing an electrical connection when the front housing 1306 is connected to the rear housing 1304 (as shown in FIG. 25). The connector 2402 shown in FIG. 24 is only one type of connector that may be used. In other examples, the connector 2402 may be differently dimensioned and/or include a number of pins/leads based on the corresponding connector 2302 within the front housing 1306.

### First Alternative Camera Module Embodiment

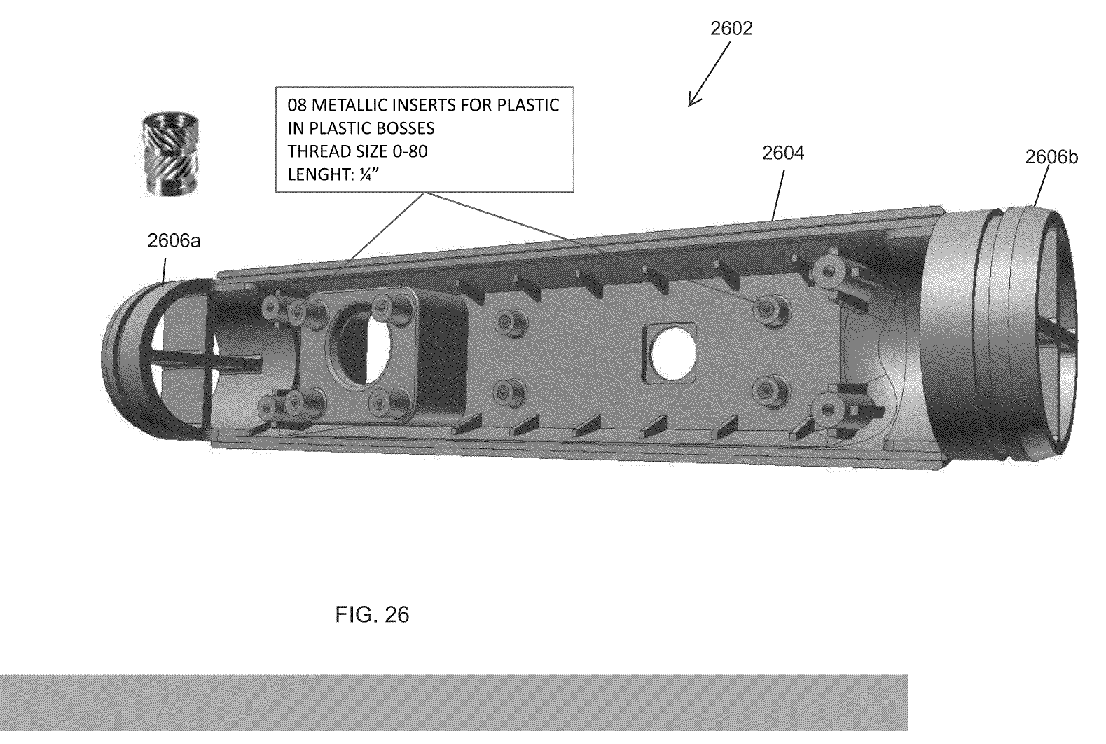

FIGS. 26 to 28 show diagrams of a first alternative camera module 206 that may be used with the camera system 104 disclosed herein. In this alternative embodiment, a front housing 2602 is connectable to other camera modules 206 and/or tube structures 208 instead of the rear housing 1304 (as shown in FIGS. 21A and 21B). FIG. 26 shows a front case 2604 of the front housing 2602 that is integrally formed with ends 2606. The circuit boards 1408, 1412, 1414, 1416, the photo detector 1410 and the camera lens 1402 may be connected to the front case 2604 in the same manner as described in conjunction with FIGS. 14 to 19.

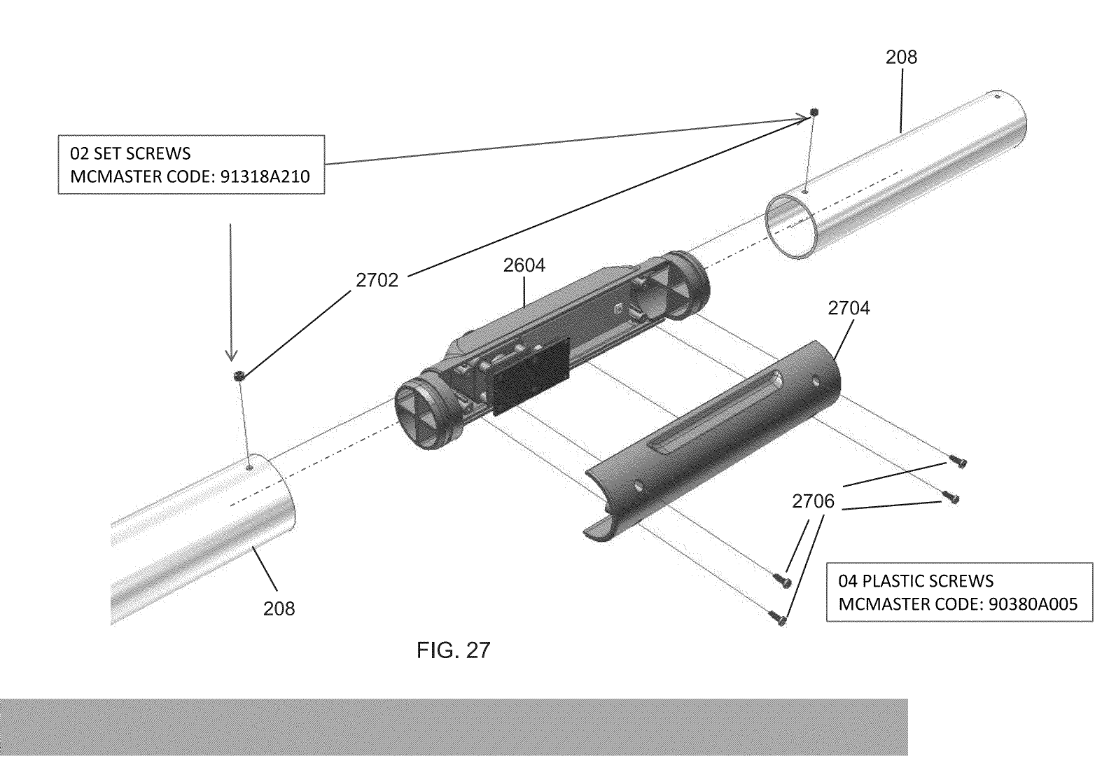

As shown in the diagrams of FIGS. 26 and 27, the ends 2606 are connectable to tube sections 208 via one or more mechanical fasteners 2702 (e.g., set screws). The portions of the ends 2606 may be rotated such that the camera module 206 may be rotated to face downward or upward while remaining securely connected to tube sections 208. The set screws 2702 may be tightened to prevent rotation or tilting of the camera module 206 after the module has been positioned as desired.

A rear housing 2704 is connectable to the front case 2604 via, for example, mechanical fasteners 2706. The rear housing 2704 may be installed after the front case 2604 has been connected to the tube sections 208 or, alternatively, prior to connecting the front case 2604 to the tube sections 208. The rear housing 2704 may be removed while the front case 2604 is installed into the camera system 104 to enable access to circuit boards and/or camera components for maintenance.

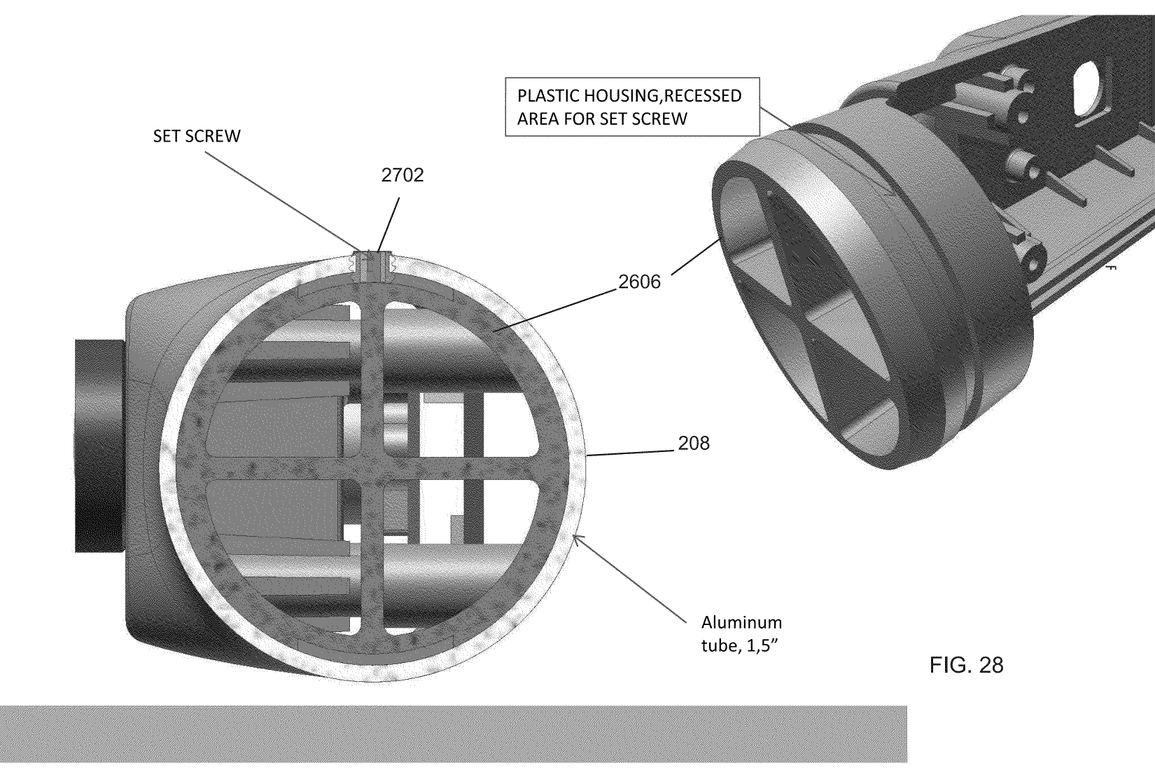

FIG. 28 shows a diagram of an enlarged perspective view of an end 2606 of the front case 2604 that includes a recessed area to accommodate a set screw 2702. As described, the front case 2604 may be rotated to a desired position and held in place by tightening the set screw 2702 into the recessed area of a portion of the end 2702 placed inside of tube section 208. While FIG. 28 shows a single set screw 2702 for each end 2606, in other embodiments, additional set screws may be connected to the end 2606.

### Second Alternative Camera Module Embodiment

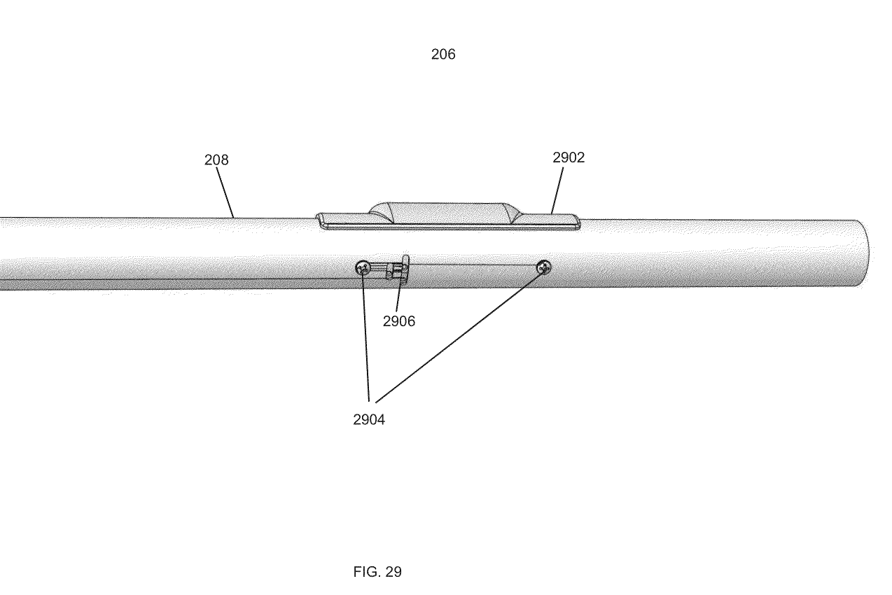

FIGS. 29 to 36 show diagrams of a second alternative camera module 206 that may be used with the camera system 104 disclosed herein. In this second alternative embodiment, a front housing 2902 is connectable to the tube structure 208 instead of the rear housing 1304. However, unlike the first alternative embodiment illustrated in FIGS. 26 to 28, the tube section 208 in FIG. 29 is used as a rear housing instead of using a separate cover.

The front housing 2902 is connectable to an area surrounding a cutout portion (or opening) of the tube structure 208. The cutout is dimensioned to accommodate the front housing 2902. The front housing 2902 is connected to the tube section 208 via, for example, connectors 2904 (e.g., mechanical screws). The tube section 208 also includes an interface portion 2906 that provides access to buttons, switches, knobs, etc. on the camera module 206. The buttons may enable the camera module 206 to be reset to original factory settings, rebooted, powered on/off, calibrated, etc.

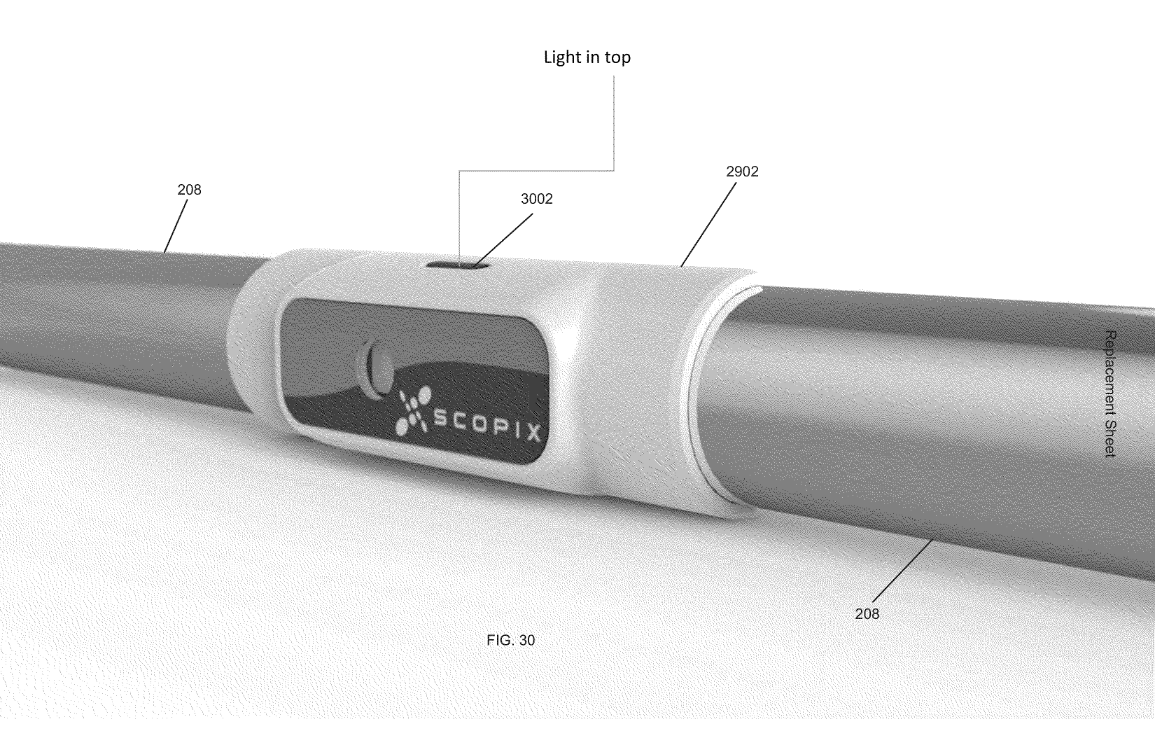

The front housing 2902 is shown as overlapping a portion of the tube section 208. For instance, FIGS. 30 to 32 show edges of the front housing 2902 extending over portions of the tube section 208. It should be appreciated that in other embodiments, the edges of the front housing 2902 may be flush with the adjacent portions of the tube section 208 as shown, for example, in FIGS. 9 and 13A to 13D.

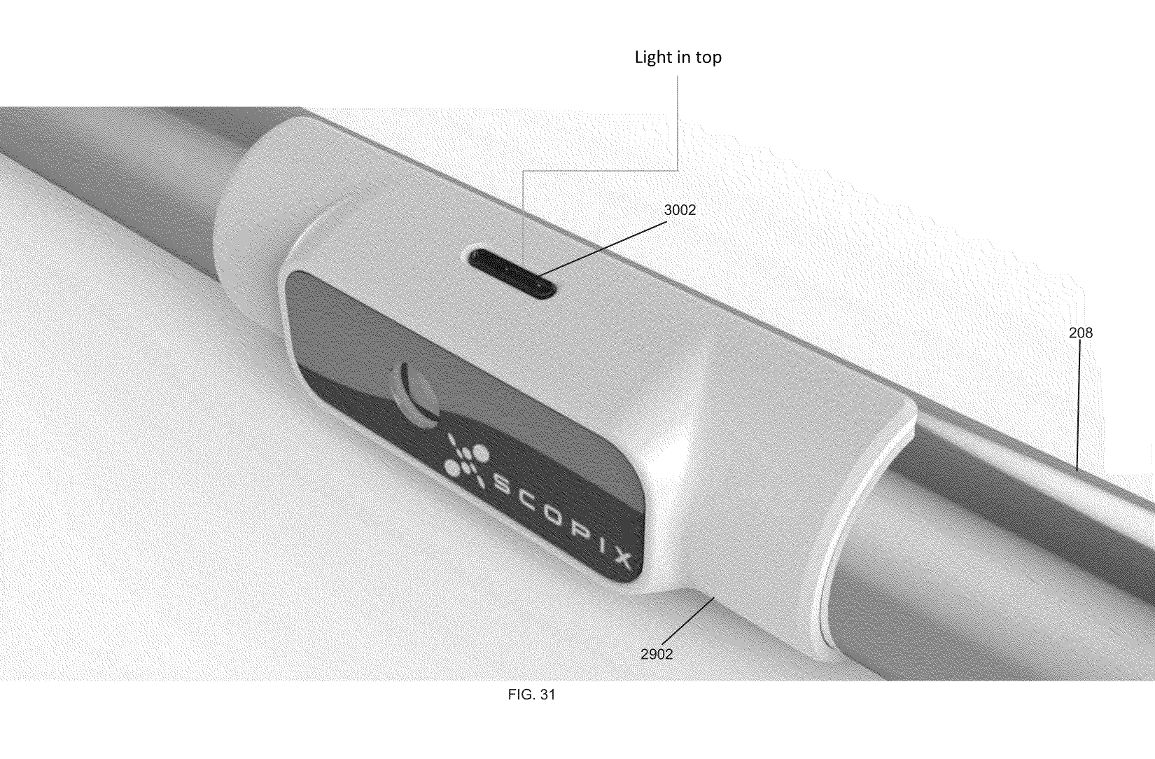

FIGS. 30 and 31 show a front perspective view of the front housing 2902 connected to the tube section 208. The front housing 2902 includes a light portion 3002, which provides illumination to indicate that the camera module 206 is operational. The light portion 3002 may also illuminate to indicate that the camera module 206 is connected to, for example, a WiFi network or a LAN network. In other instances, the light portion 3002 may illuminate to indicate there is an issue with the camera module 206. For example, the light portion 3002 may illuminate a green light to indicate that the camera module 206 is operational and a red light to indicate that the camera module 206 needs service. While the light portion 3002 is shown as being located on a top portion of the front housing 2902, in other embodiments the light portion 3002 may be located along a front face of the housing 2902, along a bottom portion of the housing 2902, or at a rear portion of the housing 2902.

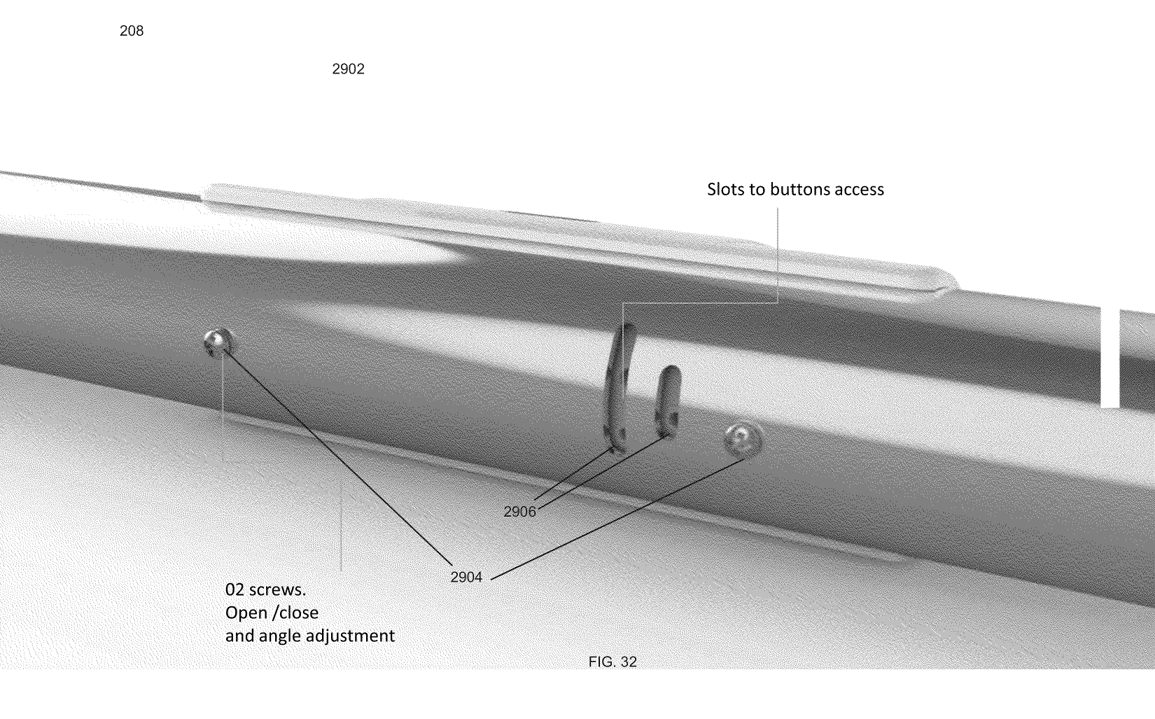

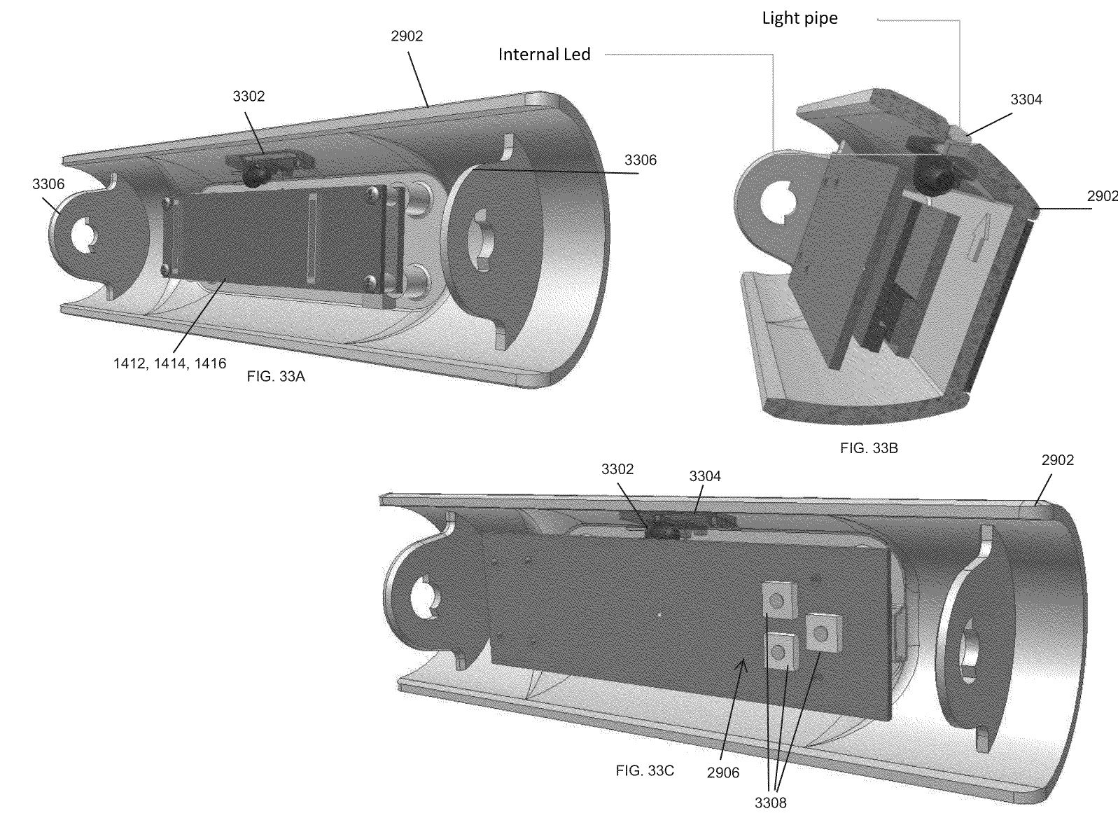

FIG. 32 shows a rear perspective view of the front housing 2902 connected to the tube section 208 via connectors 2904. In this embodiment, the tube section includes an interface portion 2906 that provides access to buttons, switches, knobs, etc. on the camera module 206. The interface portion 2906 includes openings within the tube section 208 that are aligned with buttons, switches, knobs, etc. on the camera module 206. It should be appreciated that the interface portion 2906 can include other shapes in other embodiments. It should also be appreciated that the interface portion 2906 can include additional features or components to provide access to buttons, switches, knobs, etc. on the camera module 206. For instance, the interface portion 2906 can include button extensions that enable a user to actuate or manipulate buttons, switches, knobs, etc. on the camera module 206 through the tube section 208.

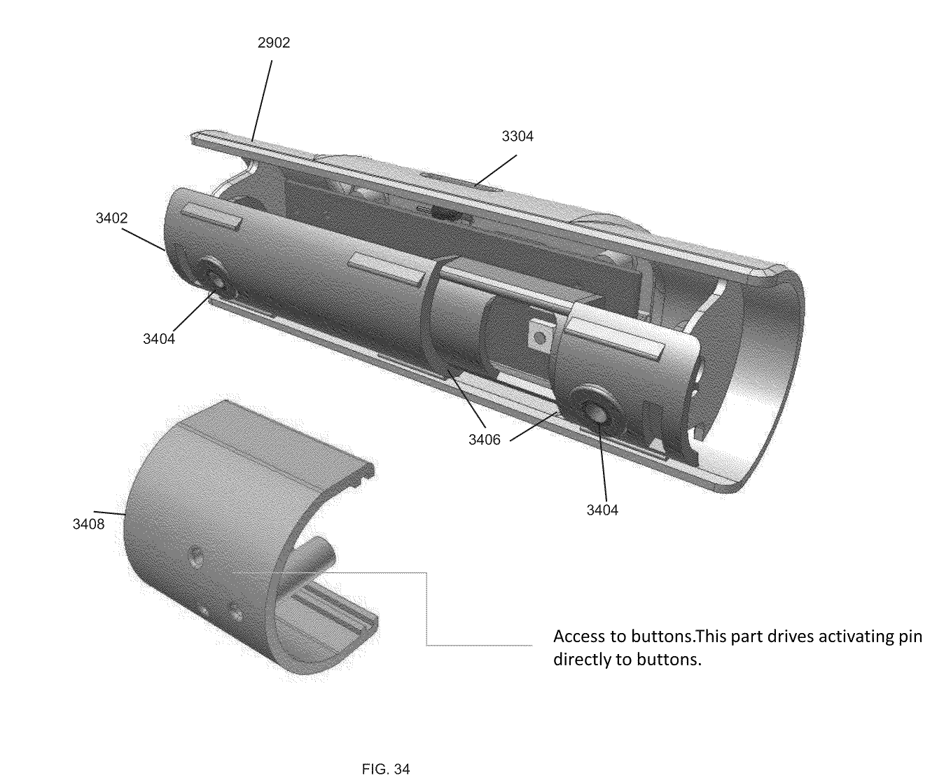

FIGS. 33A, 33B, 33C, and 34 show a diagram of a rear perspective view of the front housing 2902. The rear perspective view provides an internal view to at least some of the components of the front housing 2902 including, for example, the control circuit board 1412, the communication circuit board 1414, and/or the connector circuit board 1416 described in conjunction with FIG. 14.

In this second alternative embodiment, the front housing 2902 also includes the light portion 3002. In particular, the light portion 3002 includes at least one light emitting diode 3302 (“LED”) positioned in proximity to a light pipe 3304. The LED 3302 may include one or more light sources configured to emit different wavelengths of light. The example light pipe 3304 functions as a focusing lens such that condensed light is emitted from the front housing 2902. In some embodiments, the light pipe 3304 may be aligned with different LEDs 3302 such that different portions of the pipe propagate light from respective LEDs.

FIGS. 33A to 33C also show front housing aligners 3306 configured to align the front housing 2902 within the tube section 208 during installation. The aligners 3306 may include a cutout that is keyed to accommodate a corresponding section of the tube section 208. The aligners 3306 may enable the front housing 2902 to be rotated around the cutout portions so that the camera module 206 can be positioned for the appropriate image field. As discussed above, the alignment of the camera module 206 is based on heights of store shelves, number of camera modules deployed, distances between opposing shelves, etc.

FIG. 33C of the second alternative embodiment also shows the interface portion 2906, which includes buttons 3308. As discussed above, the buttons 3308 enable the camera module 206 to be reset, calibrated, powered on/off etc. It should be appreciated that in other embodiments, the interface portion 2906 can include additional or fewer buttons 3308. Further, in other embodiments, the interface portion 2906 can include other types of buttons, switches, levers, controls, etc. For instance, the interface portion 2906 can include a zoom toggle button that enables a camera within the camera module 206 to be manually set to record at a particular zoom level.

FIG. 34 shows the front housing 2902 including an internal rear housing 3402. The front housing 2902 is connected to the internal rear housing 3402 using any type of mechanical or chemical fastener. For instance, edges of the internal rear housing 3402 may snap-fit to correspondingly-shaped edges of the front housing 2902. In other instances, the internal rear housing 3402 may be connected to the front housing 2902 using screws. The internal rear housing 3402 is configured to attach the camera module 206 to the tube section 208 via connection points 3404. In the illustrated embodiment, the connection points 3404 include cutouts to receive screws. In other embodiments the connection points 3404 can include a snap-fit component.

The internal rear housing 3402 also includes an interface cutout 3406 that provides access to the interface portion of the front housing 2902 via an interface cover portion 3408. The cover portion 3408 includes cutouts that are aligned with, for example the buttons 3308 of the front cover 2902. The cover portion 3408 is shown as being connectable to the internal rear housing 3402. In other embodiments, the cover portion 3408 may be integrated with or integrally formed with the internal rear housing 3402.

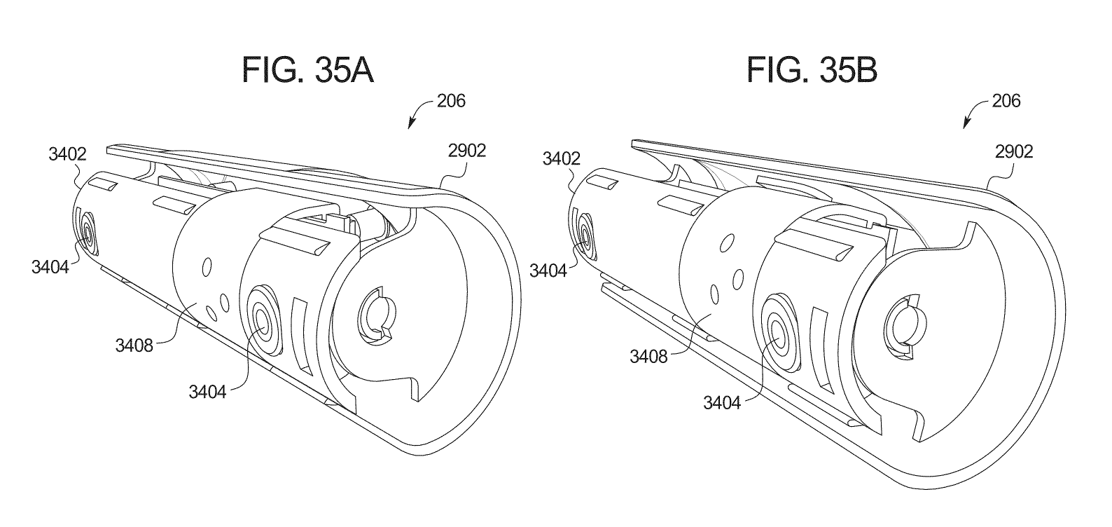

FIGS. 35A and 35B show that the cover portion 3408 can be used to connect the internal rear housing 3402 to the front housing 2902 via a tab that contacts, for example, the connector circuit board 1416. FIGS. 35A and 35B also show how the camera housing 2902 is connected to the internal rear housing 3402 and the interface cover portion 3408 to enable the camera module 206 to rotate within the pipe section 208.

In particular, FIG. 35A shows that camera module 206 is in a relatively horizontal position and FIG. 35B shows the camera module 206 with 20 degrees of rotation. As can be seen in FIGS. 35A and 34B, the cover portion 3408 rotates with the front housing 2902 while the internal rear housing 3402 remains fixed in place via connection points 3404. The rotation is provided by the interface cover portion 3408 rotationally sliding within the interface cutout 3406 of the internal rear housing 3402.

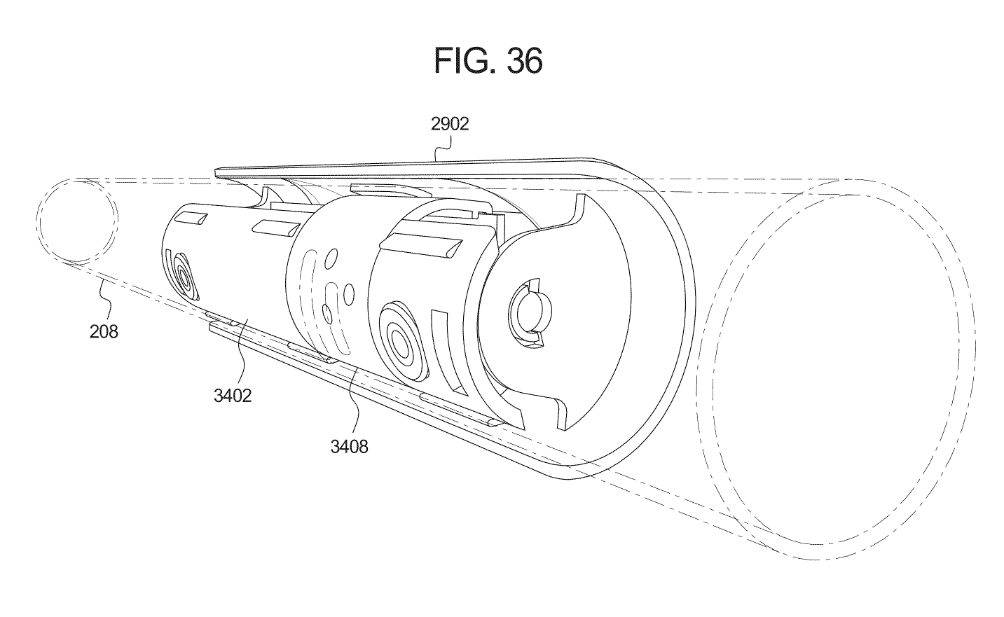

FIG. 36 shows a diagram of a rear-perspective of the front housing 2902 connected to the tube section 208. In this figure the tube section 208 is partially transparent to visualize how the front housing 2902, the internal rear housing 3402, and the interface cover portion 3408 are disposed within the tube section 208. It should be appreciated that a portion of the front housing 2902 may rotate over portions of the tube section 208 when the camera module 206 is being rotated or tilted to a desired position. In other instances, edges of the front housing 2902 may be substantially flush, aligned with, or recessed from corresponding edges of the tube section 208.

It will be understood that modifications and variations may be effected without departing from the scope of the novel concepts of the present invention, and it is understood that this application is to be limited only by the scope of the claims.

The invention is claimed as follows:

1. An apparatus comprising:
a tube-shaped object including a camera seat portion, the tube-shaped object being positioned along a top of a first store shelf that is adjacent to a second store shelf, the first and second store shelves being separated by an aisle; and
a camera module connected to the tube-shaped object at the camera seat portion and including:
a camera housing having edges that align with edges of the camera seat portion;
a camera having a lens that is positioned to image at least a portion of the second store shelf; and
a transmitter configured to transmit images of the portion of the second store shelf to a communicatively coupled server.

2. The apparatus of claim 1, wherein the camera module is configured to transmit images of at least one product located on the second store shelf.

3. The apparatus of claim 1, wherein the camera module is communicatively coupled to a server and configured to transmit (i) an image of at least one product located on the second store shelf and (ii) an identifier of the camera module.

4. The apparatus of claim 3, wherein the server is configured to make the image available to a third party associated with a product included within the image.

5. The apparatus of claim 3, wherein the server is configured to:
determine from the image that a product type located on the second shelf is to be reordered; and
transmit an order request for a quantity the product type.

6. An apparatus comprising:
an elongated housing configured to be mounted to a retail store shelving unit, the housing including at least two cameras configured to face a second adjacent shelving unit.

7. The apparatus of claim 6, wherein the at least two cameras are positioned so as to provide overlapping coverage to provide an image of a section of the second adjacent shelving unit longer than the field provided by one of the cameras.

8. The apparatus of claim 7, wherein the at least two cameras are communicatively coupled to a sever configured to (i) receive image data from each of the at least two cameras, (ii) combine the image data from each of the at least two cameras to create a complete image of the second shelving unit, and (iii) make the combined image available to a third party.

9. The apparatus of claim 7, wherein the server is configured to send a first message to a first camera instructing the first one of the cameras to at least one of zoom, pan, and tilt and send a second message to a second one of the cameras instructing the second camera to at least one of zoom, pan, and tilt in a manner different from the first camera.

10. The apparatus of claim 6, wherein the elongated housing is mounted to at lest one of a top of the retail store shelving unit and a front ledge at a mid section of the retail store shelving unit.

11. The apparatus of claim 6, wherein the elongated housing has a profile similar to that of the retail store shelving unit.

12. The apparatus of claim 6, wherein the elongated housing includes a camera connector including a first side configured to connect a first one of the cameras and a second side configured to connect to a second one of the cameras, the camera connector including separator that enables the first one of the cameras to be rotated in a direction separate from the second one of the cameras.

13. An apparatus comprising:
a tube-shaped camera connector section having a length along a first axis and including:
first and second ends configured to be connected to a tube-shaped object, the first and second ends having a diameter that is substantially equal to a diameter of the tube-shaped object; and
a camera seat portion including an exterior face section connected to portions of the first and second ends so as to form an opening exposing an interior of the camera seat portion to accommodate a camera housing such that edges of the camera housing are adjacent to edges of the exterior face section and the first and second ends.

14. The apparatus of claim 13, wherein the camera seat portion includes at least one mechanical connector and at least one electrical connector connected to the interior camera seat portion.

15. The apparatus of claim 14, wherein the camera housing includes:
at least one mechanical connector configured to attach the camera housing to a corresponding mechanical connector of the camera seat portion; and
at least one electrical connector configured to electrically couple the camera housing to a corresponding electrical connector of the camera seat portion.

16. The apparatus of claim 14, wherein the camera housing includes a camera having a lens that is positioned along a second axis tangential to the first axis.

17. The apparatus of claim 14, further comprising at least one leg section configured to connect the tube-shape camera connector section to a shelving unit, the at least one leg section having an adjustable length to enable a height of the tube-shape camera connector section relative to the shelving unit to be changed.

18. An apparatus comprising:
a tube-shaped object including a cutout portion forming an opening exposing an interior of a portion of the tube-shaped object; and
a camera module connected to the tube-shape object such that the camera module is located within the cutout portion with edges of the camera module overlapping edges of the cutout portion, the camera module including:
an internal rear cover including at least one mechanical connector to connect the camera module to the tube-shaped object, and
an interface portion that enables the camera module to rotate within the cutout portion of the tube-shaped object while the internal rear cover and the tube-shaped object remain stationary.

19. The apparatus of claim 18, wherein the camera module includes at least one light indicative of an operational state of the camera module.

20. The apparatus of claim 18, wherein the camera module includes at least one button configured to reset the camera module to a manufacturing setting and the interface portion provides outside access to the button on the camera module.
